(19) United States
(12) Patent Application Publication
(10) Pub. No.: US 2007/0107708 A1
(43) Pub. Date: May 17, 2007

(54) Diesel engine egr control device and motor drive type throttle valve device

(75) Inventors: Yasuhisa Uchiyama, Hitachinaka (JP); Yasuhiro Kamimura, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 10/580,850

(22) PCT Filed: Nov. 28, 2003
(86) PCT No.: PCT/JP03/15271

§ 371 Date: May 26, 2006

(51) Int. Cl. F02M 25/07; F02B 47/08

(52) U.S. Cl. 123/568.18; 123/568.21; 123/568.24

(57) ABSTRACT

An apparatus for enhancing the control response of EGR recirculation rate. For EGR control, this apparatus contains a throttle valve for controlling the opening of an engine air intake passage (i.e. throttle valve for EGR control), and an EGR valve for controlling the flow rate of the exhaust gas recirculated into the air intake passage. The apparatus also includes a first air intake body containing the throttle valve, drive motor thereof and reduction gear mechanism, and a second air intake body containing the EGR valve, drive motor thereof and reduction gear mechanism. The first and second air intake bodies are connected with each other to form an integral assembly and are equipped with the first and second covers for protecting the respective reduction gear mechanisms. At least a circuit board for controlling the drive of the reference value is incorporated in at least one of said covers. The circuit board can be equipped with a circuit for controlling the drive of the EGR valve, in addition to the throttle valve.

### FIELD OF THE TECHNOLOGY

The present invention relates to an exhaust gas recirculation (EGR) control device used in the internal combustion engine for a diesel vehicle, and a motor-driven throttle valve device used therein.

### BACKGROUND OF ART

The EGR is known as a means to reduce the nitrogen oxides (NOx) in the exhaust gas of the internal combustion engine. One of the conventional electronic EGR gas control devices is the one wherein an on-off valve is provided in the EGR gas passage close the connection between the intake manifold and EGR gas passage, and a motor is used for on-off control of this valve through a reduction gear (Official Gazette of Japanese Patent laid-open 2002-521610).

In another conventional art, a bent tube for taking in EGR gas is arranged in an air intake passage downstream from a throttle valve and this bent tube is made to open toward the on the downstream side of the air intake passage. At the same time, the EGR gas passage connected to the intake tube is provided by a valve, and the on-off control of this valve is provided by a negative pressure actuator (Japanese Application Patent Laid-open Publication No. Hei 10-213019).

Further, an electronically controlled throttle valve apparatus (motor driven throttle device) is offered for commercial use in a gasoline engine over an extensive range, wherein the drive control of a throttle valve is made by an actuator (e.g. DC motor, torque motor, stepping motor), whereby the optimum control of the flow rate of the intake air is ensured.

In this case, the actuator is used to provide control in such a way as to ensure that the opening of the throttle valve reaches the target opening computed from the accelerator stroke and engine operation conditions. Further, the behavior of the throttle valve is sensed by a throttle position sensor, and the position is connected through feedback control.

In the meantime, the diesel engine utilizes the compression heat of air to ignite the fuel. It provides engine drive control by controlling only the amount of fuel injection, not the intake air flow rate. Such being the case, the diesel engine does not require use of such a throttle valve as that of gasoline engine vehicle.

In recent years, however, an electronically driven throttle valve drive device has been used in the diesel engine as well, due to the requirements for improved EGR efficiency and dieseling performance, unlike the requirements of the gasoline engine.

In the electronically driven throttle valve drive device for diesel engine, the throttle valve is located at a full opening position if EGR or dieseling preventive measures are not provided, unlike the case of a gasoline engine. The opening of the throttle valve is controlled in the EGR control mode, whereby EGR efficiency is improved. The diesel engine may involve so-called dieseling wherein the intake air coming inside when the engine is stopped is expanded by the engine heat, thereby actuating the engine temporarily. To avoid this problem, control is provided to ensure that the throttle valve is forcibly closed when the engine is stopped.

Conventionally, the control circuit of the throttle valve for diesel engine and the EGR valve control circuit for controlling the amount of exhaust gas to be recirculated has been arranged inside the engine control unit (ECU).

In the diesel engine, when the control circuit of the electronically controlled throttle valve is installed in the engine control unit, the theoretical load of the engine control computing section becomes too high relative to the current ECU microcomputer capability. For example, electronically controlled throttle valve controlled cycle reaches the level of 8 through 16 ms. If the electrical throttle valve apparatus is controlled at a controlled cycle of 8 through 16 ms, the controllability (overshoot and convergence to the target opening) will be reduced.

The present invention provides an EGR control device for diesel engine and a motor driven throttle valve apparatus capable of ensuring improved controllability.

### SUMMARY OF THE INVENTION

The present invention provides an EGR control device wherein part of the exhaust gas is recirculated into the air intake passage of a diesel engine, and this EGR control device basically has the following structure.

The EGR control device comprises a throttle valve for controlling the opening of the air intake passage of an engine for EGR control (i.e. a throttle valve for EGR control), and an EGR valve for controlling the amount of exhaust gas to be recirculated to the air intake passage.

The EGR control device comprises a first air intake body further including a throttle valve, a drive motor thereof and a reduction gear mechanism; and a second air intake body further including a EGR valve, a drive motor thereof and a reduction gear mechanism.

The first and second air intake bodies are joined to each other so as to be integrated into an assembly. Each of the first and second air intake bodies is provided with the first and second cover sections for covering each reduction gear. At least the circuit board for controlling the drive of the throttle valve is incorporated into either of the aforementioned covers. The circuit board may be provided with a circuit for controlling the drive of the EGR valve, in addition to the throttle valve.

In the present invention, the throttle valve control circuit is independent of the ECU. Especially, the aforementioned control circuit is installed on the air intake passage body equipped with a throttle valve through the cover. Thus, the drive of the throttle valve is controlled based on the air intake passage body. This arrangement reduces the load of the diesel engine ECU, and allows the behavior of the throttle valve and EGR valve to be sensed at a very close position. The signal noise can be reduced and control response performance can be improved, based on the result of detection.

In particular, when EGR control normally at a full opening position and control for avoiding dieseling are to be implemented, the throttle valve for EGR control is characterized by a unique operation of controlling the throttle valve opening. In the present invention, the air intake body of the throttle valve and the control circuit thereof are integrally built. This structure allows the control circuit to separately memorize the mechanical throttle full opening and full closing positions in the air intake body as a single body, wherein the aforementioned full opening and full closing positions serve as the basic points required for EGR control. This improves the accuracy of the actual throttle valve opening relative to the target opening, and the EGR rate control accuracy with reference to intake air in the EGR control.

Further, if the throttle valve control circuit and the EGR valve control circuit required for EGR control are provided on the cover side of the throttle body, integration between the control circuit and EGR related mechanism can be achieved. Moreover, this arrangement reduces the number of the wire harnesses between the control circuits and between the control circuit and actuator or shortens the wire harness. It also improves the resistance to noise and promotes efficiency inside the engine room of the electronic equipment.

The present invention further proposes the following device as a motor driven throttle valve device capable of ensuring the optimum integration of the aforementioned control circuit and EGR related equipment.

The throttle valve device is equipped with a throttle valve and an EGR valve used for EGR control. It is also provided with a first air intake body equipped with the throttle valve, a drive motor thereof and a reduction gear mechanism; and a second air intake body into which an exhaust gas recirculation passage part with the EGR valve is incorporated, and which is equipped with a drive motor of said EGR valve and a reduction gear mechanism. The second air intake body is connected to the first air intake body in series at downstream from said first air intake body. The first and second air intake bodies are provided with a first and second covers for covering reduction gear mechanisms respectively. A throttle valve shaft and an EGR valve shaft are arranged in parallel in the vertical direction. The reduction gears for these shafts and the first and second covers are arranged in parallel on the side surface of the first and second air intake bodies.

The aforementioned cover sections can be structured either-separately or integrally. The structure of this motor driven throttle valve can be used for the gasoline engine as well as the diesel engine, and will ensure preferable integration of the control circuit and related equipment.

### BRIEF DESCRIPTION OF THE DRAWINGS

FIG. 1 is a perspective view showing the partial cross section of an exhaust gas recirculation control device (EGR apparatus) as an embodiment of the present invention;

FIG. 2 is a vertical sectional view representing the part thereof;

FIG. 3 is a side view of the aforementioned embodiment;

FIG. 4 is a transverse cross sectional view of the aforementioned embodiment;

FIG. 5 is a top view of the aforementioned embodiment;

FIG. 6 is an enlarged cross sectional view showing the EGR valve drive mechanism in the aforementioned embodiment;

FIG. 7 is an enlarged partial cross sectional view showing the throttle valve drive mechanism in the aforementioned embodiment;

FIG. 8 is a side view showing another side of the aforementioned embodiment;

FIG. 9 is a side view showing of the aforementioned embodiment wherein a cooling apparatus is removed;

FIG. 10 is schematic diagram representing the engine system using the EGR control device to which the present invention is applied;

FIGS. 11 and 12 are block diagrams showing the EGR controller in the aforementioned embodiment;

FIG. 13 is a flow chart representing the specific control items of the EGR controller in the aforementioned embodiment;

FIG. 14 is a partial cross sectional view showing a first configuration of the recirculating gas flow rate sensor used in the EGR control of the aforementioned embodiment;

FIG. 15 is a partial cross sectional view showing a second configuration of the recirculating gas flow rate sensor used in the EGR control of the aforementioned embodiment;

FIG. 16 is a diagram showing the characteristics resulting from the differences in the drive method of the throttle valve used in the aforementioned EGR control;

FIG. 17 is a diagram showing the characteristics resulting from the differences in the drive method of the throttle valve used in the aforementioned EGR control;

FIG. 18 is a block diagram showing a control system in another embodiment of the EGR control device of an internal combustion engine to which the present invention is applied;

FIG. 19 is a schematic diagram showing the map used in still another embodiment of the aforementioned EGR control;

FIG. 20 is a flow chart showing the specific control items of the exhaust gas recirculation controller in the aforementioned embodiment;

FIG. 21 is a system schematic diagram in the first form of the embodiment of the electronically controlled throttle device;

FIG. 22 is an explanatory diagram showing the characteristics of the throttle valve opening in the first form of the embodiment of the electronically controlled throttle device used in the aforementioned embodiment;

FIG. 23 is an explanatory diagram defining the throttle valve opening in the first form of embodiment used in the aforementioned embodiment;

FIG. 24 is a vertical sectional view of the aforementioned first form of embodiment;

FIG. 25 is a sectional view as seen in the direction of arrow V-V of FIG. 24;

FIG. 26 is a perspective view showing the throttle position sensor in the aforementioned first form of embodiment;

FIG. 27 is a circuit diagram showing the throttle position sensor in the aforementioned first form of embodiment;

FIG. 28 is a view as seen in the direction of the arrow A in FIG. 25 wherein the gear cover is removed;

FIG. 29 is a view as seen in the direction of the arrow A in FIG. 25 wherein the gear cover and intermediate gear are removed;

FIG. 30 is a view as seen in the direction of the arrow A in FIG. 25 wherein the gear cover, intermediate gear and final-stage gear are removed;

FIG. 31 is a plan showing inside the gear cover in the first form of embodiment of the aforementioned electronically controlled throttle device;

FIG. 32 is a plan showing inside the gear cover of FIG. 31 wherein a circuit protective plate (covering member) is removed;

FIG. 33 is a schematic diagram representing the throttle actuator control unit (TACU) in the first form of embodiment of the electronically controlled throttle device used in the present invention;

FIG. 34 is a circuit diagram showing the H bridge circuit in the first form of embodiment of the electronically controlled throttle device;

FIG. 35 is a flow chart showing the specific control items of the control section in the first form of embodiment of the electronically controlled throttle device;

FIG. 36 is an explanatory diagram showing the specific control items of the control section in the first form of embodiment of the electronically controlled throttle device;

FIG. 37 is a flow chart showing the specific control items of the control section in the second form of embodiment of the electronically controlled throttle device;

FIG. 38 is an explanatory diagram showing the specific control items of the control section in the second form of embodiment of the electronically controlled throttle device;

FIG. 39 is a flow chart showing the specific control items of the control section in the third form of embodiment of the electronically controlled throttle device;

FIG. 40 is a flow chart showing the specific control items of the control section in the fourth form of embodiment of the electronically controlled throttle device;

FIG. 41 is an explanatory diagram showing the specific control items of the control section in the fourth form of embodiment of the electronically controlled throttle device;

FIG. 42 is a system configuration diagram showing another form of embodiment of the aforementioned electronically controlled throttle device;

FIG. 43 is an explanatory diagram showing an example of the system configuration of the EGR control section in the present invention;

FIG. 44 is an explanatory diagram showing the control unit of the throttle valve used therefor;

FIG. 45 is an explanatory diagram showing an example of the system configuration of the EGR control section in the present invention;

FIG. 46 is a plan representing a cover and control circuit used in another embodiment of the EGR control device of the present invention;

FIG. 47 is an explanatory diagram showing the operation waveform of the voltage reducing circuit of the embodiment used in FIG. 46;

FIG. 48 is an explanatory diagram showing an example of the system configuration of the EGR control device in the present invention;

FIG. 49 is a block diagram showing the control unit of the throttle valve used in FIG. 48 and the peripheral equipment thereof;

FIG. 50 is a cross sectional view showing another embodiment of the motor driven throttle valve apparatus in the present invention;

FIG. 51 is a cross sectional view showing still another embodiment of the motor driven throttle valve apparatus in the present invention;

FIG. 52 is a plan representing a gear cover and a circuit board used in a further embodiment of the motor driven throttle valve apparatus in the present invention; and

FIG. 53 is a system schematic diagram showing a further embodiment of the EGR control device of the present invention.

### BEST MODE FOR CARRYING OUT THE INVENTION

Referring to the drawings, the following describes the details of embodiments of the present invention.

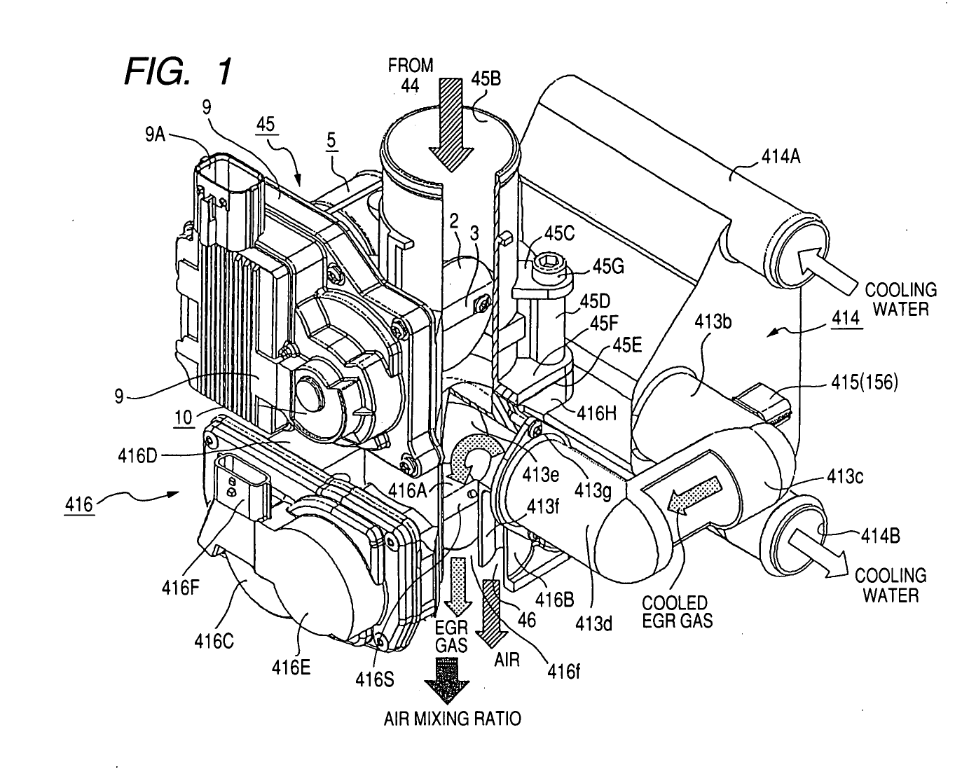

FIG. 1 is an overall perspective view showing an EGR control device of the present invention, wherein a partial cross section of an air intake passage is displayed to show the interior.

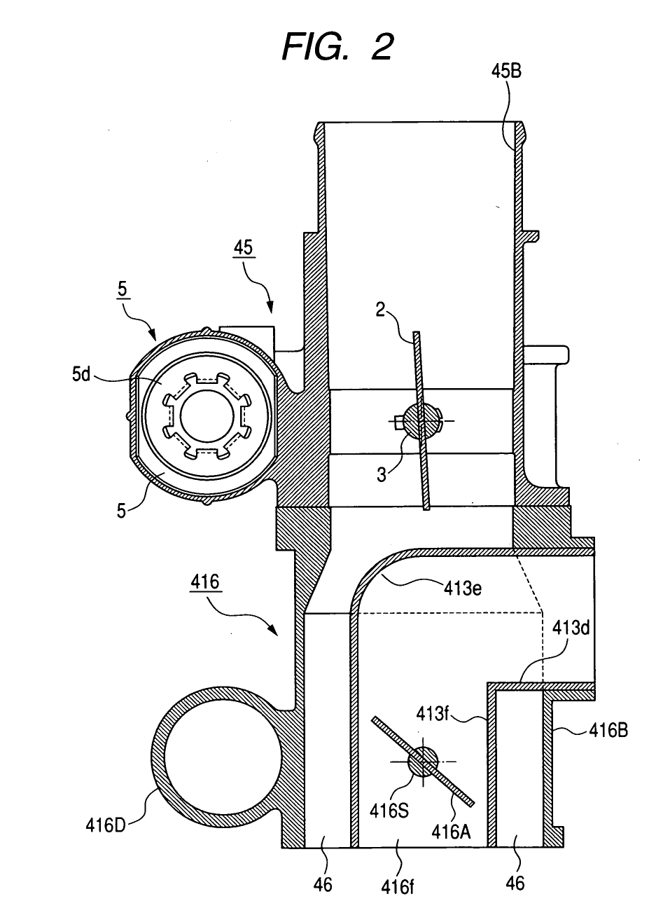

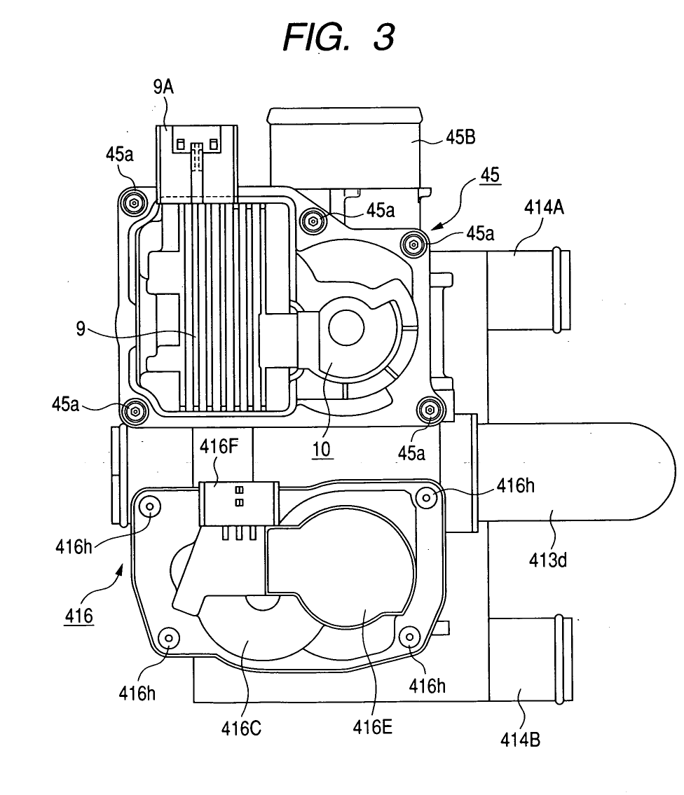

FIG. 2 is a vertical sectional view representing an EGR control device, and FIG. 3 is a side view thereof.

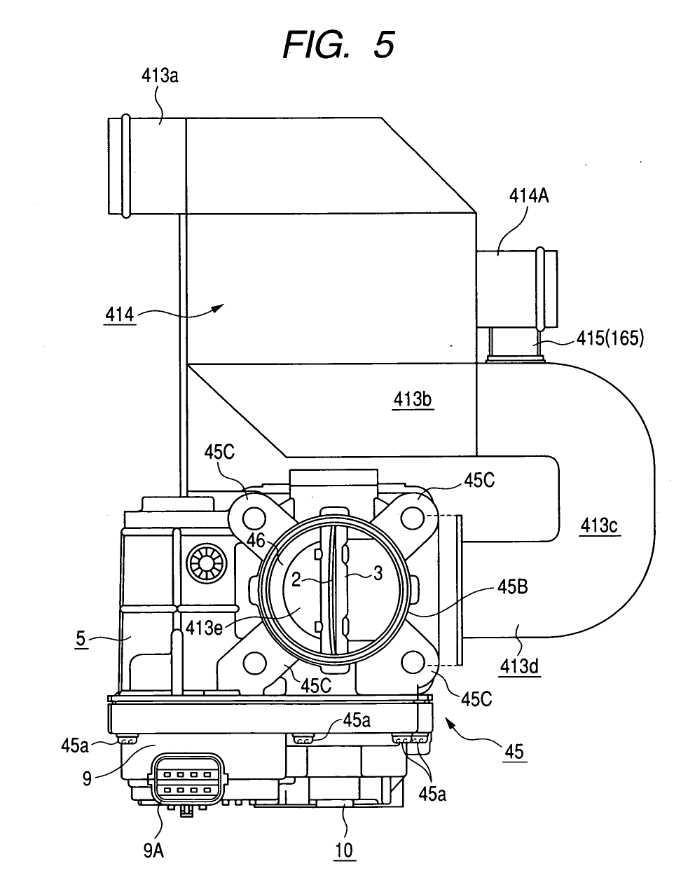

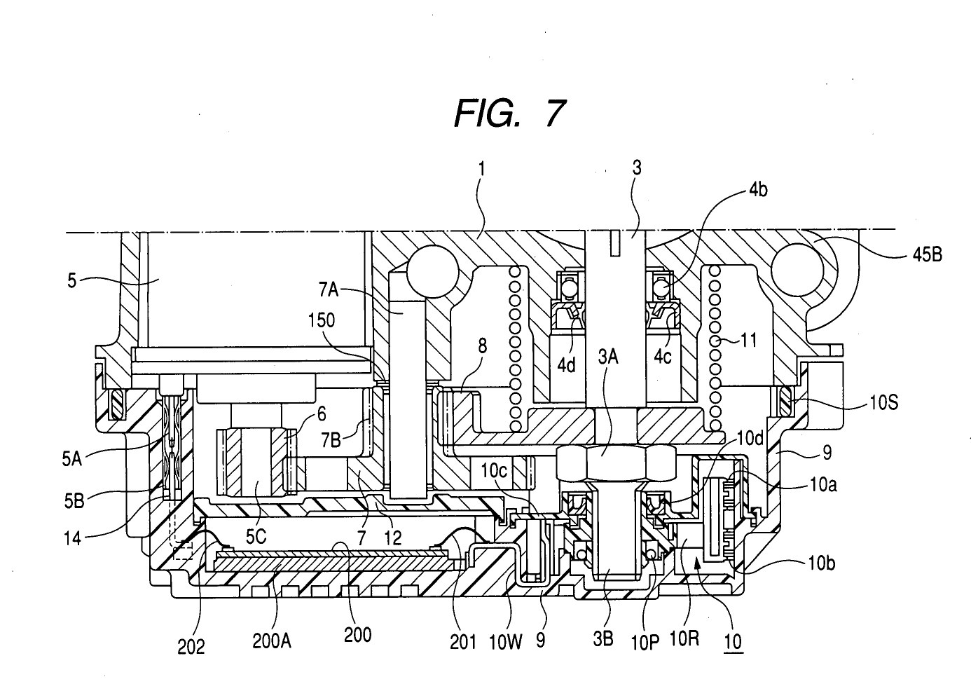

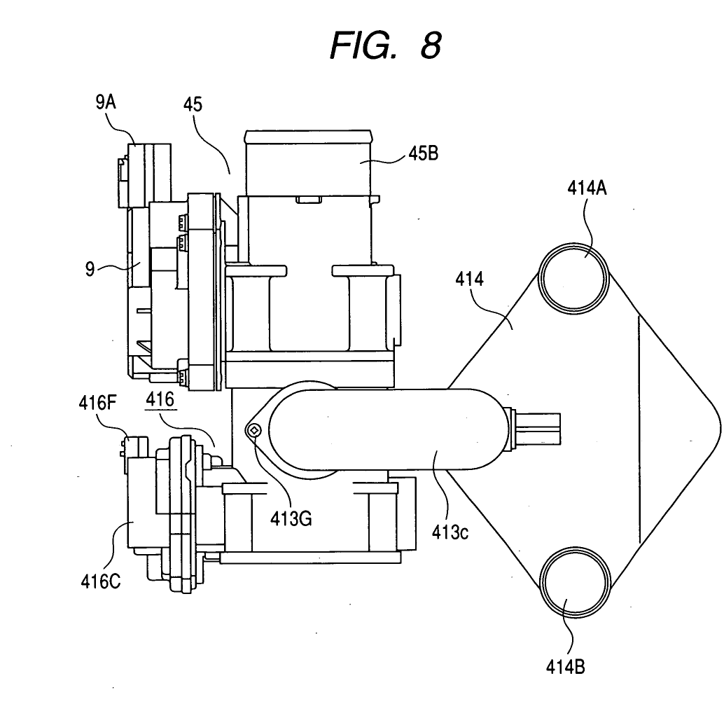

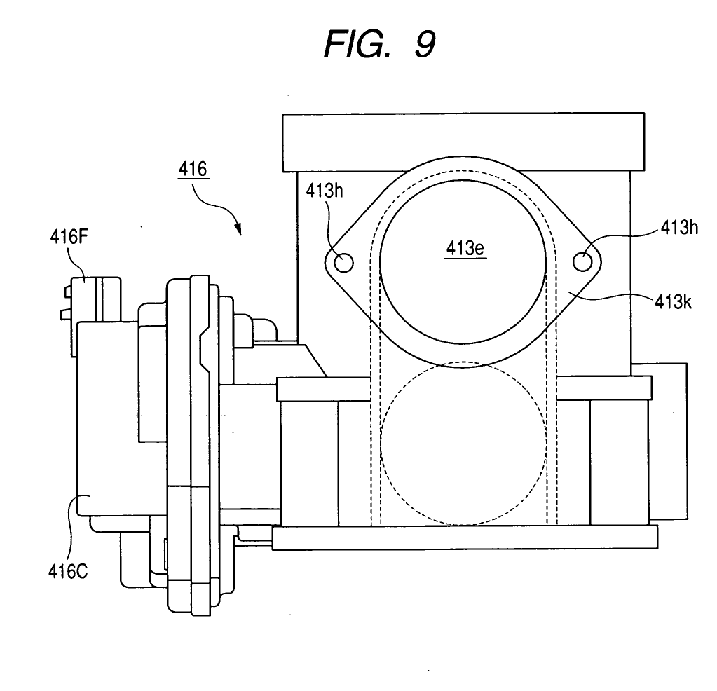

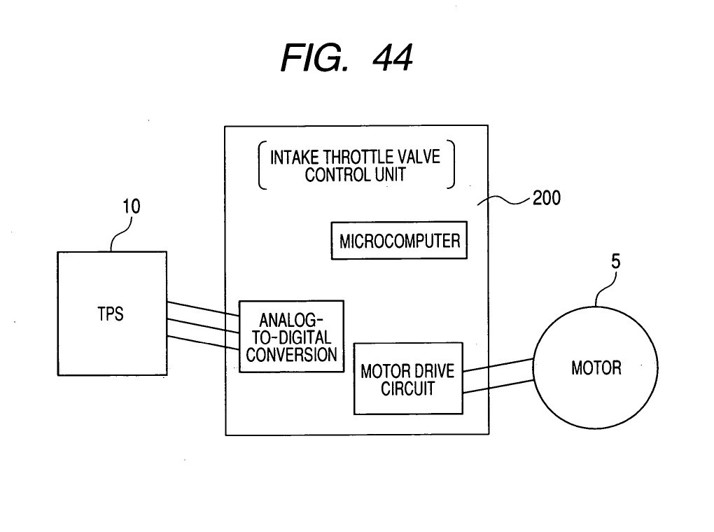

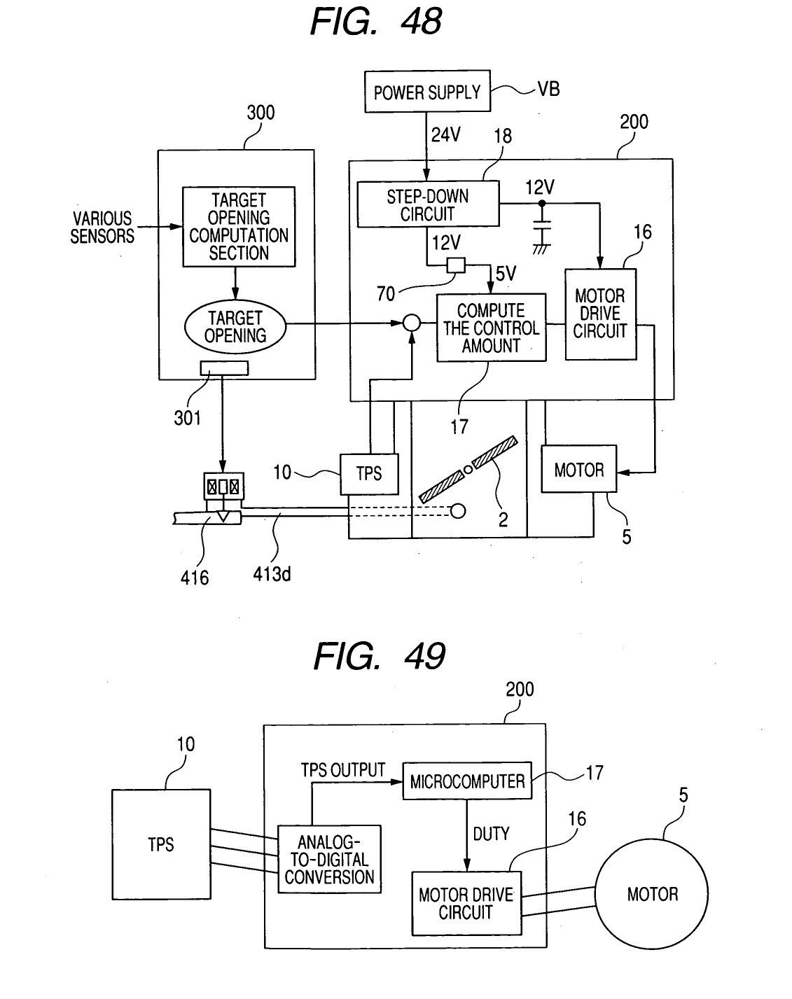

In the first place, the overview of the present invention will be described with reference to FIGS. 1 through 9 and FIGS. 43 through 53.

The following describes a basic arrangement of the present invention.

The EGR control device 416 comprises a throttle valve 2 for controlling the opening of an air intake passage 46 of the engine, and an EGR valve 416A for controlling the flow rate of exhaust gas recirculated to the air intake passage 46. A part of exhaust gas recirculating pipe (an EGR elbow pipe constituted with pipe sections 413d, 413e and 413f) is inserted into the air intake passage 46, and the EGR valve 416A is arranged into the EGR elbow pipe member.

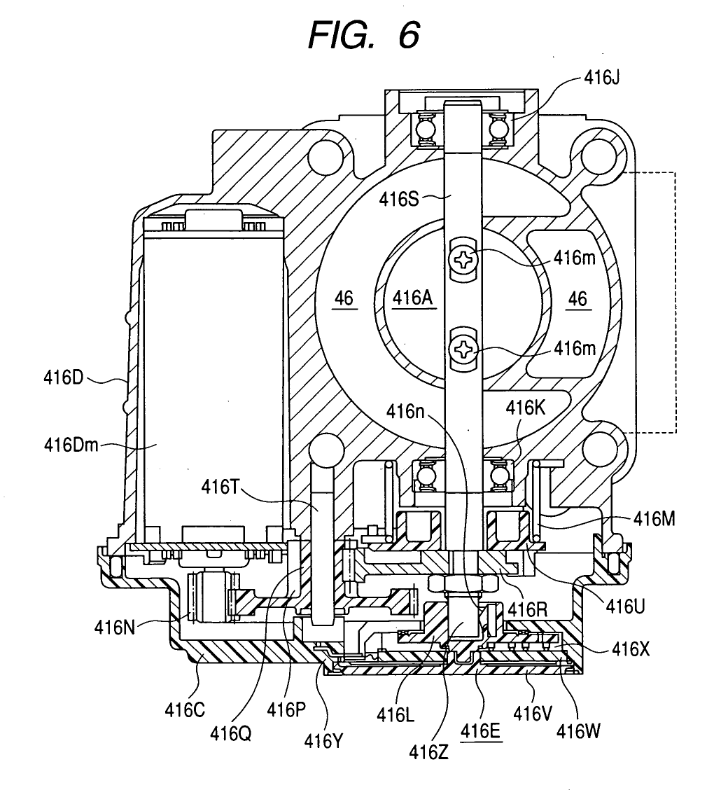

An air intake body (a first air intake body) 45B forming a part of the air intake passage 46 is equipped with a throttle valve 2, its drive motor 5 and a reduction gear mechanisms (6, 7 and 8) (FIGS. 6 and 7).

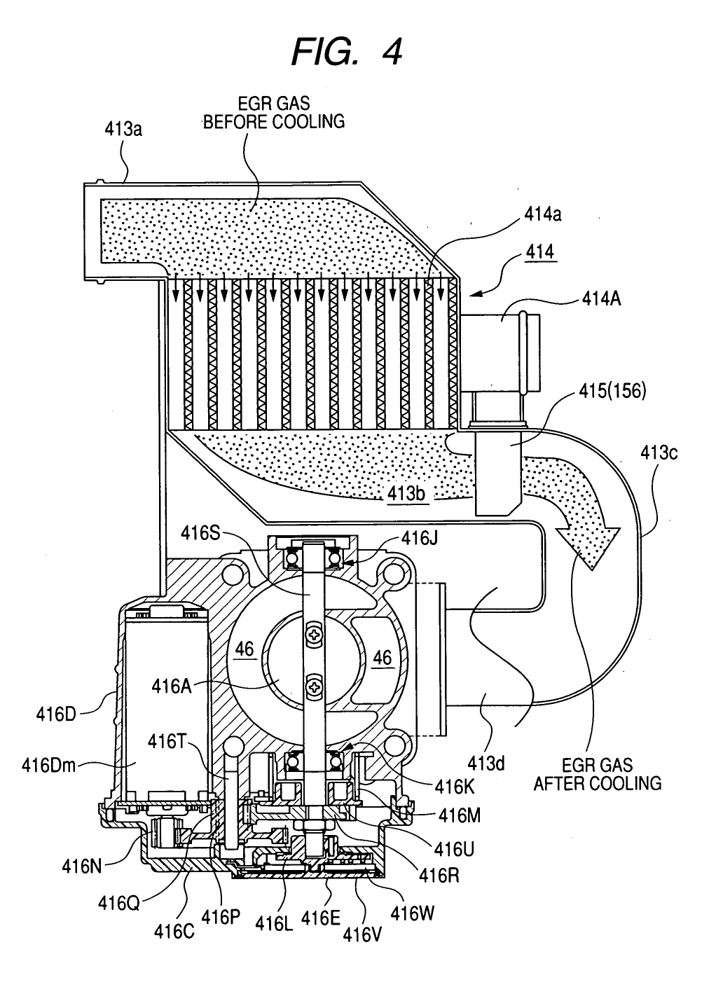

One end of the exhaust gas recirculation pipe having with the EGR valve 416A is inserted into an air intake body (second air intake body) 416B, which is equipped with a EGR valve drive motor 416Dm and a reduction gear mechanisms (416N, 416P, Q and 416L) (FIG. 4).

The first and second air intake bodies 45B and 416B are so jointed to each other as to form an integral assembly, and are provided a first cover 9 and a second cover 416c for covering each of the reduction gear mechanism.

A circuit board 200 for driving and controlling at least the throttle valve 2 (also called as “a butterfly valve or an intake flow rate control valve”) is incorporated into either one or both of the first cover section 9 and the second cover 416c. For example, in case of this embodiment, the circuit board is incorporated into the first cover 9 through a metallic plate (heat sink) 200A (FIG. 7). The circuit board 200 can also be provided a control circuit for driving and controlling the EGR valve. When the circuit board 200 is equipped with the control circuit for the EGR valve, the EGR drive control signal is sent to the EGR valve motor 416Dm from a connecter terminal section 9A of the first cover 9 (a cover on the side of the throttle valve drive mechanism) through a connector terminal section 416F.

In the present example, the first cover 9 and the second covers 416c are separately formed. They may be formed as an integral component and the circuit board 200 may be incorporated into this cover. In this case, the connector 416F for external connection can be omitted.

In the present embodiments, the first cover 9 and the second covers 416c are arranged close to each other in parallel in the vertical direction on the side in the same direction of an outer wall of a throttle bodies (45′ and 46′). The following consideration is taken in order to achieve such an arrangement of these covers 9 and 416c.

The second air intake body 416B is arranged in series with the first air intake body 45B on the downstream side of the first air intake body 45B. A drive shaft 3 of the throttle valve 2 and a drive shaft 416S of the EGR valve 416A are arranged in parallel in the vertical direction. In this manner, the reduction gears (6, 7, 8, 416N, 416P and 416q) of the drive shafts 3 and 416S, and the first and second covers 9 and 416c are arranged in parallel on the side of the first and second air intake bodies. Although not illustrated in the embodiment, this layout is capable of molding easily the first and second covers in single piece.

The connectors 9A and 416F are oriented toward the upstream side of the throttle valve. This is intended for easier connection or disconnection of the connector terminal and the external wire hardness when the device is mounted in an engine room.

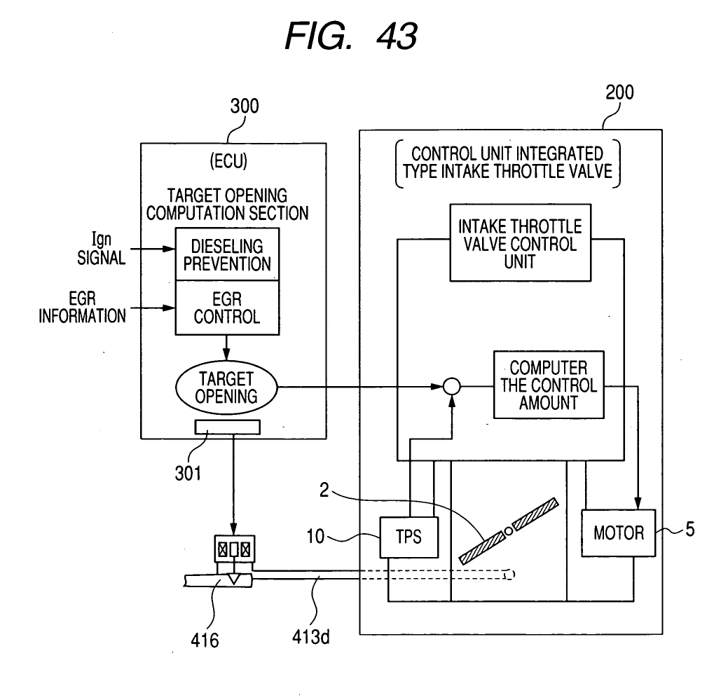

Referring to FIGS. 43 through 53, the following describes the specific examples of the structures and operations of the circuit board 200 for EGR control of the present invention and an ECU 300 outside the cover.

FIG. 43 is a block diagram showing the first control example.

The circuit board 200 is incorporated in the cover 9 of the throttle body 45B. These assemblies are collectively called a throttle valve devise integrated with a control unit in some cases. The major component of the ECU 300 is a microcomputer.

In FIG. 43, the circuit board 200 incorporated in the gear cover 9 is provided with a drive control circuit for driving the throttle valve for EGR. The ECU 300 takes in information inputted from various sensors for identifying the engine status, e.g. an engine speed, an intake air flow rate, a cooling water temperature, an accelerator opening, a vehicle speed, an EGR flow rate and an EGR temperature. The ECU 300 determines if the system is in the EGR mode or not. If it is in the EGR mode, the ECU 300 computes the respective target openings of the throttle valve and the EGR valve suitable for EGR control (EGR rate: ratio between an intake air flow rate and an exhaust gas flow rate.

Based on the result of the computation, the ECU 300 controls the opening of the EGR valve actuator 416 by operating the drive circuit 301. Furthermore, for the throttle valve 2, the ECU 300 sends the target opening signal to the circuit board 200 (it's also called as “throttle valve control unit”). The throttle valve control unit 200 mainly comprising a microcomputer compares an actual opening information from a throttle valve opening sensor (throttle position sensor) 10 with the target opening, and controls the motor 5 (e.g. DC motor) so that the throttle valve 2 reaches the target opening.

In order to avoid dieseling, the ECU 300 sends the target opening instruction (throttle full closing) of the throttle valve to the throttle valve circuit board 200 when the ignition signal is turned off (engine stops). In response to this instruction, the unit 200 computes difference between the target opening of the throttle valve and the actual opening, and controls the motor under the duty control by using the drive circuit. Dieseling refers to a problem specific to the diesel caused by the diesel engine's air intake passage being opened at the time of engine stop.

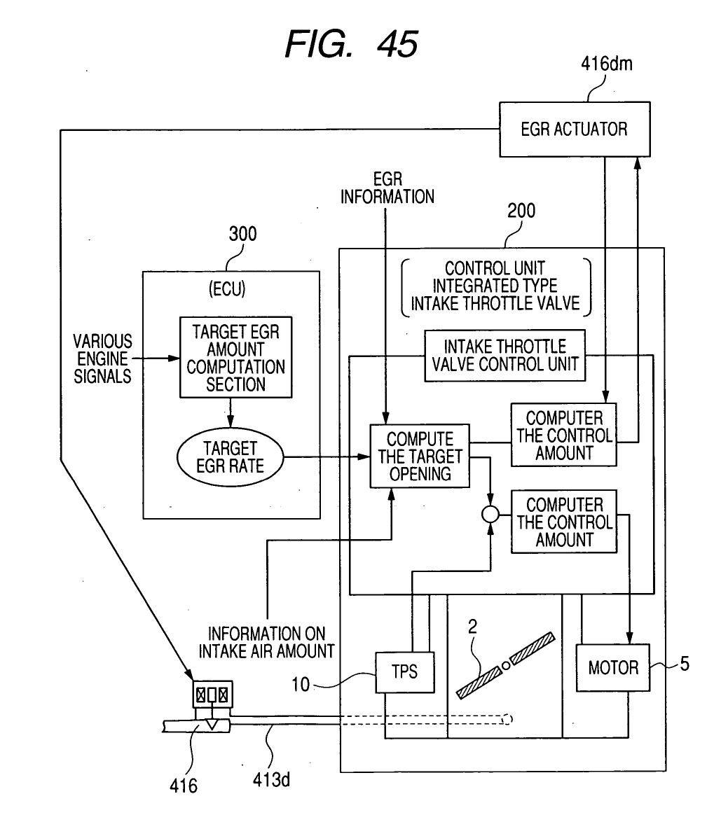

In the example of FIG. 45, the ECU 300 computes the target EGR rate according to the engine rotation speed, intake air flow rate, cooling water temperature, accelerator opening and vehicle speed. The target openings of the throttle valve and the EGR valve are respectively computed by the circuit board (throttle valve control unit) 200 in the gear cover 9. The throttle valve control unit 200 computes the aforementioned respective target opening based on the target EGR and EGR information (e.g. the quantity of EGR and temperature of EGR). For the EGR valve, the unit 200 also computes the EGR valve control rate (required duty) according to the target opening. Based on the result of computation, the unit 200 drives and controls the EGR valve motor 416Dm, and controls the opening of the EGR valve 416. The unit 200 computes the target opening of the throttle valve 2 based on the target EGR rate and the intake air flow rate information, and then computes the control amount of the throttle valve according to the difference between the target opening and the actual opening. Based on the result of this computation, the unit 200 drives the motor 5 and controls the throttle valve 2.

In FIG. 45, the ECU 300 may be provided with a dieseling preventive control function.

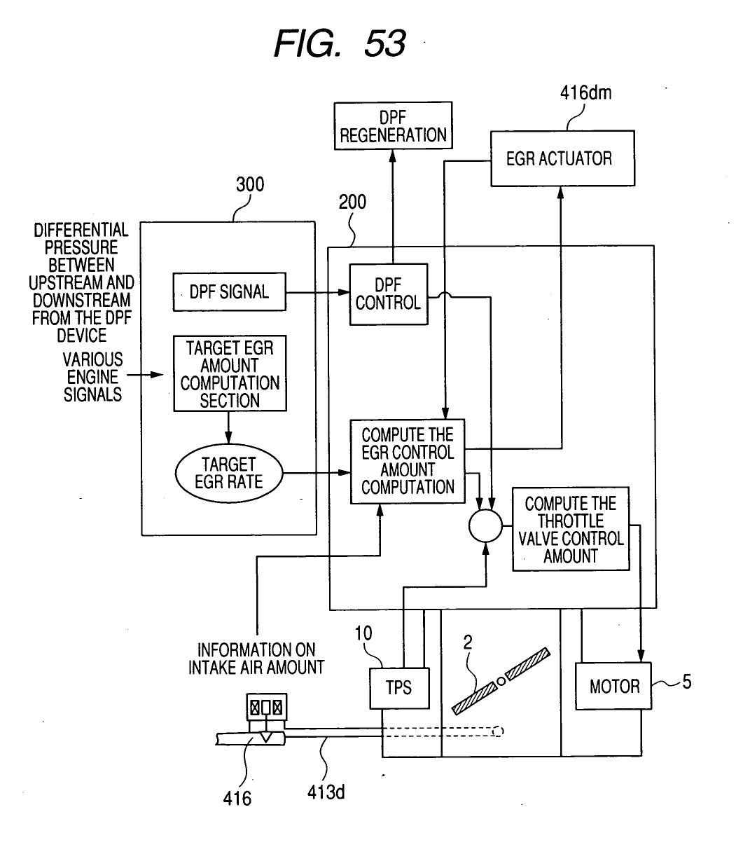

FIG. 53 shows an example of a system wherein the EGR control and DPF (diesel particulate filter) regeneration control is implemented. The DPF is installed in the exhaust pipe and is used to capture the diesel smoke particles contained in the exhaust gas. The flow of the exhaust gas through the DPF is deteriorated by clogging resulting from long-time use. To solve this problem, the particles are removed by forcibly after-burning at the DPF, thereby the DPF is reusable. This regeneration procedure is implemented as follows. A differential pressure between upstream and downstream from the DPF is measured. If the differential pressure ΔP becomes smaller than or equal to a predetermined value, the ECU 300 sends the DPF regeneration instruction to the throttle valve control unit (circuit board) incorporated in the gear cover 9. Based on the DPF instruction, the unit 200 outputs the opening instruction signal for reducing the opening of the throttle valve 2, and computes a throttle valve control amount according to the difference between this opening instruction signal and the actual opening information. The motor 5 is driven according to the throttle valve control amount. Thus, the throttle valve 2 reduces the intake air flow rate supplied to the engine, and the temperature of the exhaust gas is increased. Consequently, the particles deposited on the DPF are burnt out. In this case, a heater provided to the DPF is also heated based on the DPF regeneration instruction signal to encourage particle combustion and DPF regeneration. The aforementioned description also applies to the EGR control.

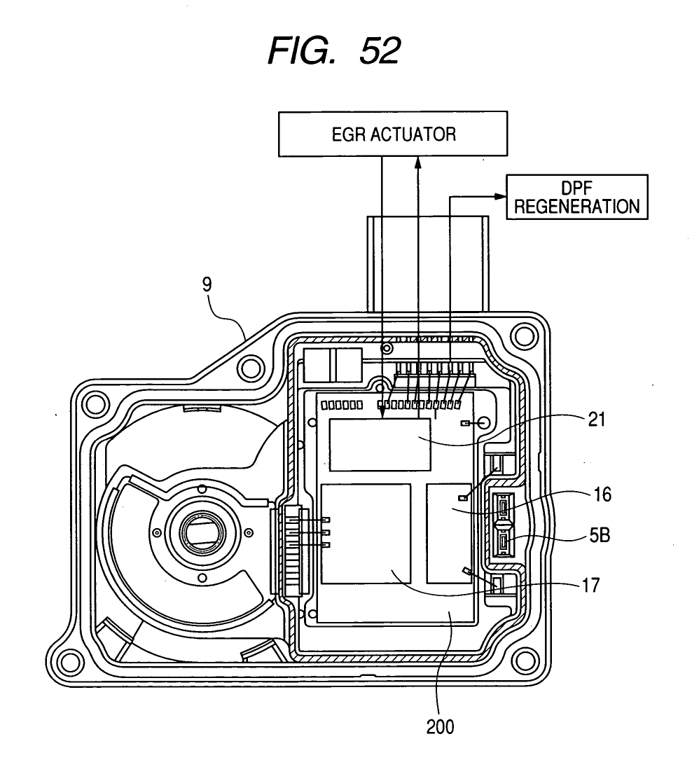

FIG. 52 shows that the circuit board 200 of FIG. 53 is installed in the gear cover 9. The circuit board 200 is provided with a throttle valve control circuit 17, a motor driver 16 and an EGR valve actuator control circuit 21. Further, the throttle valve control circuit 17 is provided with a DPF control circuit so as to output the DFP regeneration instruction signal.

Installing the circuit board 200 in the gear cover of an air intake body means that the circuit board 200 is placed under severe temperature conditions. Especially in the case of the diesel engine, the temperature inside the engine room thereof is higher than that of a gasoline engine. In particular, when the engine is stopped immediately after long-term operation under a heavy load, the temperature condition is extremely severe. This requires some cooling measures to be taken to protect the circuit board 200.

In the present invention, the following measures have been taken to solve this problem.

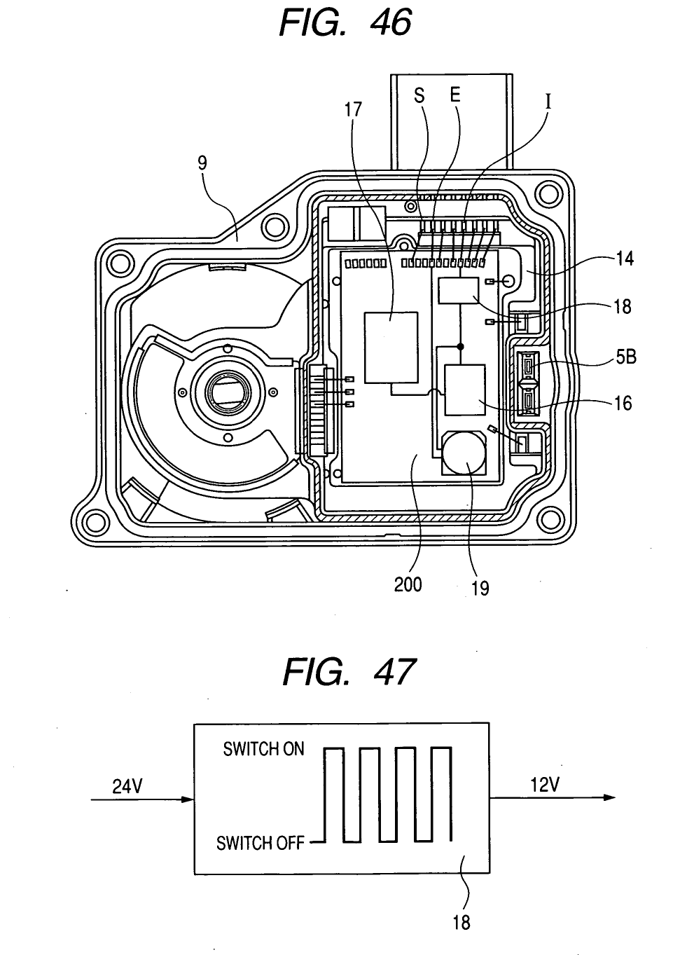

In the examples of FIGS. 46 through 49, the present invention is applied to a particularly large-sized diesel vehicle (the circuit board 200 installed in the gear cover), and this will provide effective measures against heat. According to the conventional art, the concept of providing a vehicle system powered by a diesel engine with a throttle valve is not commonly accepted. Accordingly, the aforementioned circuit board (throttle valve control unit) 200 has not been installed in the gear cover 9 of the air intake body in the prior art. In the large-sized vehicle such as a diesel truck, a 24-volt battery is used as a vehicle power supply. On the other hand, a 12-volt battery is used as a gasoline engine power supply. Therefore, in the 24-volt vehicle system, when adopting the existing electronically controlled throttle system, which has been used for gasoline engine until now, the 24-volt vehicle system requires a converter for converting the voltage from 24 to 12 volts. If the 24-volt power is applied to an electronic circuit of the electronically controlled system without being reduced from 24-volt or the motor 5 is modified to meet the 24-volt requirement, the Joule heat will be increased. This is not preferred for the circuit board used in the aforementioned severe temperature environment. If the electronic circuit temperature has been increased, correct operation of the electronic circuit will be interrupted and the system shutdown may be caused by self-diagnosis.

In the present example, EGR throttle valve drive motor is driven by using a step-down circuit 18 for reducing the motor drive power supply from 24 to 12-volt.

To put it more specifically, for example, a DC-to-DC converter is used as the step-down circuit. The DC-to DC converter performs quick turning on and off of the switch, as shown in FIG. 47, whereby voltage is reduced from 24 to 12 volts by the PWM control. The DC-to-DC converter is characterized by high efficiency. Since the reduced power is not consumed in the DC-to DC converter as the step-down circuit, this method reduces the generated Joule heat effectively, as compared to the case of using a resistor for step-down. It should be noted that the EGR control is implemented in the same way as in the aforementioned embodiment.

As shown in FIG. 46, in addition to the EGR control circuit (microcomputer) 17, a motor driver 16 and noise preventive capacitor 19, the aforementioned step-down circuit 18 is mounted on the circuit board 200 incorporated in the gear cover 9. The terminal (I) is a battery power supply terminal and is connected with the motor driver 16 through the step-down circuit 18. The 12-volt power is supplied to the motor 5 from the motor driver 16 through the motor terminal 5B. The noise preventive capacitor 19 is connected to the power line between the step-down circuit and motor driver, and is connected to the ground terminal E.

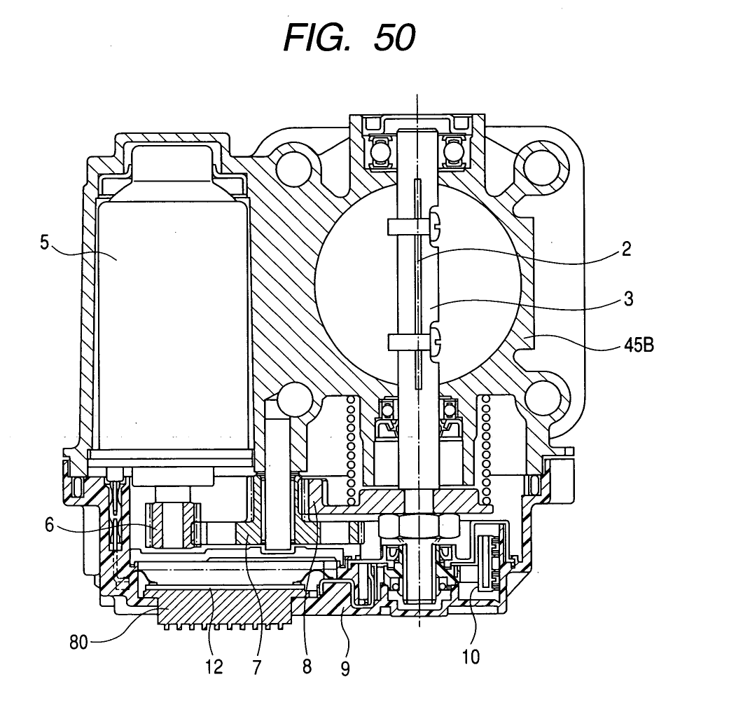

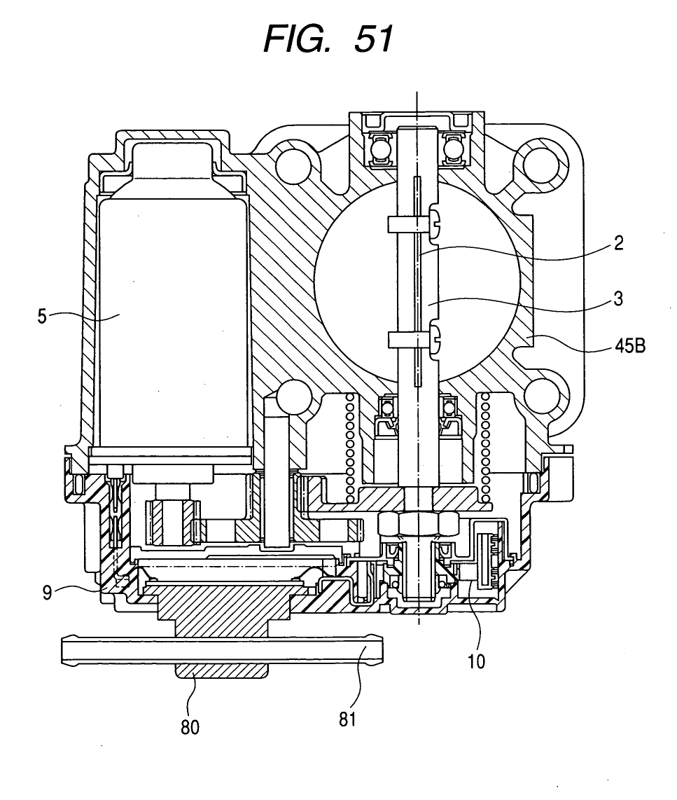

FIGS. 50 and 51 show another circuit cooling device. The circuit board 200 of FIG. 50 is supported by a metallic plate (e.g. aluminum plate) 80 having a higher thermal conductivity than the resin cover 9. This metallic plate 80 is led through the resin cover 9 and is mounted thereon. The heat radiating surface of the metallic plate 80 is exposed to the outside of the cover 9. The heat radiation efficiency of the control circuit can be improved by the present embodiment. Other structures are the same as those of other embodiments.

The metallic plate 80 of FIG. 51 is provided with a cooling water pipe 81, and the engine cooling water flows through the cooling water pipe 81. Since the maximum temperature of the engine cooling water is generally 90° C., it is lower than the temperature inside the engine room immediately after running of the vehicle. This arrangement provides more effective cooling effects.

The following describes the details of the embodiment of the present invention.

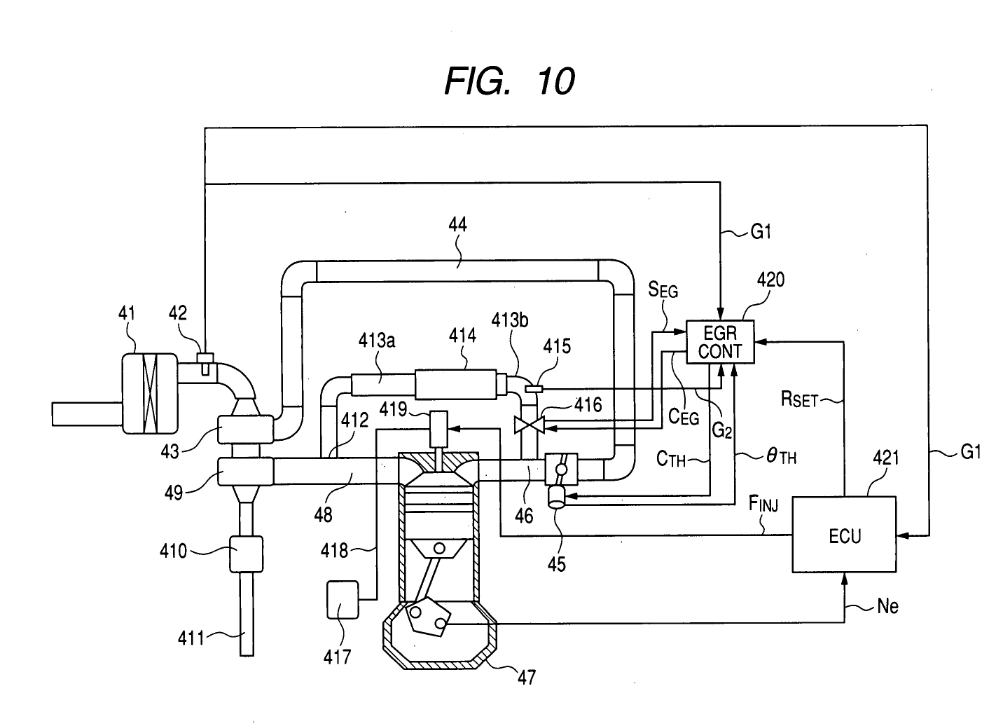

The reference numeral 416 corresponds to the EGR (Exhaust Gas Recirculate) control device 416 (referred to also as “exhaust gas recirculation control device in the present embodiment) in the figure of the present system (FIG. 10). The reference numeral 45 corresponds to the air intake control device described in the figure of the exhaust gas recirculation system (to be described later) (FIG. 10). The air intake control device 45 includes an air intake passage member 45B formed in a cylindrical shape, a rotational shaft 3 crossing the center axis line the cylindrical air intake passage member 45B and being supported rotatably by the air intake passage member 45B, and a butterfly valve 2 (throttle valve or air intake control valve) fixed to this rotational shaft 3 (also called a throttle shaft).

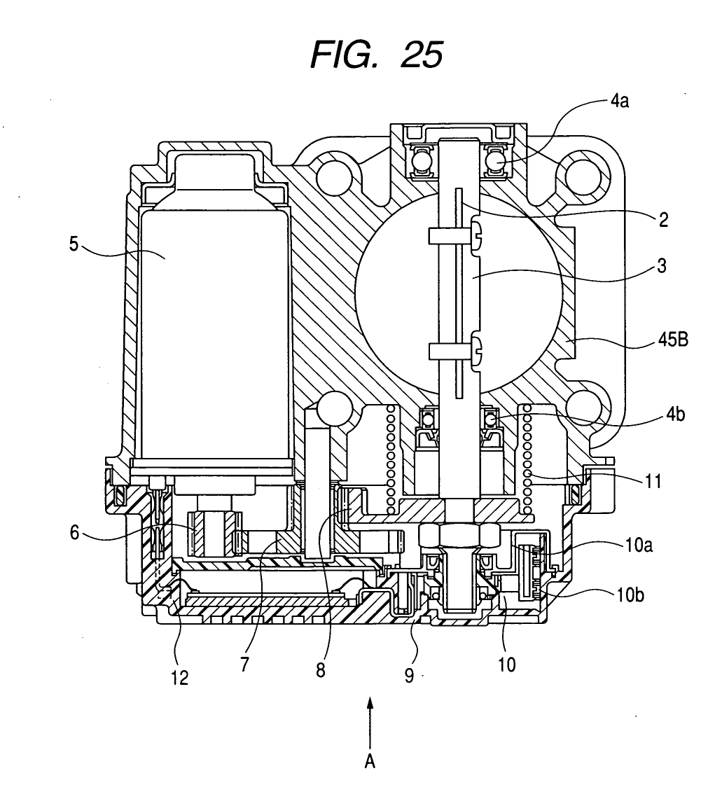

On the outer wall of the air intake passage member 45B, a motor casing arranged in parallel with the rotational shaft 3 is molded together with the air intake passage member 45B in single-piece. (For details, see FIGS. 24 and 25).

Inside of a resin cover is provided with a control circuit board (to be described later) and a rotation angle sensor for the rotational shaft 3.

The resin cover 9 is fixed at a predetermined position on the outer wall of the air intake passage member 45B by means of five screws 45a.

A connector 9A is integrally molded together with the resin cover 9. The connector 9A is provided with a terminal for sending the information from the sensor 10 to an engine control unit, a terminal for supplying power to the motor, a ground terminal and a terminal for receiving the opening control signal of the air intake control valve 2 from the engine control.

The exhaust gas recirculation control device 416 comprises a concentric double-pipe type passage structure of the air intake passage member and an exhaust gas recirculating passage member. A pipe connecting-hole is provided on the side wall of the air intake passage member. In the exhaust gas recirculating passage part, an exhaust gas inlet side passage section 413d thereof is inserted into the pipe connecting-hole and formed integrally together with a cylindrical passage section 413f extending along the axis line of the air intake passage member through the curve section 413e.

To put it more specifically, an EGR elbow passage member for EGR (it's constituted by passage sections 413d, 413e and 413f) are inserted into the air intake passage member 46 from below upward, and the exhaust gas inlet side passage section 413d is inserted into the pipe connecting-hole of the side wall.

When inserting the EGR elbow passage member (413d, 413e and 413f) into the air intake passage, in the first step of the inserting process, the EGR elbow passage member is inserted into the air intake passage 46 in a state offset from the center of the air intake passage 46 in the direction wherein the cylindrical passage section 413f goes away from the hole of the side wall. After then, the elbow passage member (413d, 413e and 413f) are moved toward the center of the air intake passage at the position wherein one end of the exhaust gas inlet side passage section 413d meets the pipe connecting-hole on the side wall. The exhaust gas inlet side passage section 413d is then inserted into the pipe connecting-hole on the side wall.

In order to implement this assembling work, the inner diameter of the air intake passage member, the outer diameter of the cylindrical passage section 413, and dimension of the exhaust gas inlet side passage section 413d up to the inner surface on the side wall of the air intake passage member are determined in the present embodiment for the purpose of ensuring the aforementioned offset. That is, in order to ensure that the EGR elbow passage member (413d, 413e and 413f) is inserted into the air intake passage in a state offset from the center of the air intake passage 46 (offset in the direction where the cylindrical passage section 413f is moved away from the pipe connecting-hole on the side wall), the longest distance between the outer wall surface of the cylindrical passage section 413f and the tip end of the exhaust gas inlet side passage section 413d is designed so as to be approximately the same as the inner diameter of the air intake passage 46. The longest distance between the outer wall surface of the cylindrical passage section 413f and the tip end of the introductory passage section 413d can be greater than the inner diameter of the air intake passage 46. In this case, when the EGR elbow passage member (413d, 413e and 413f) must be inserted into the air intake passage 46 in a tilted position to set the exhaust gas inlet side passage section 413d into the pipe connecting-hole of the side wall. In order to do the assembling work easily, the cylindrical passage section 413f is shorter than the exhaust gas inlet side passage section 413d.

When the exhaust gas inlet side passage section 413d is set into the pipe connecting-hole of the side wall, the center axis line of the cylindrical passage section 413f conforms to that of the air intake passage 46, whereby setting in a double-pipe configuration of an EGR passage part and the air intake passage is provided.

It goes without saying that perfect conformance between the center axis lines of the two is not required. Rather, in some cases, the preferred position of the cylindrical passage section 413f should be a slightly offset from the center of the air intake passage 46 (in the direction where the cylindrical passage section 413f moves away from the hole on the side wall) because of the resistance and streamline of the fluid.

The side wall of the air intake passage 46 and the cylindrical passage section 413f of the EGR elbow passage member (413d, 413e and 413f) are provided with through-holes for the rotational shaft at the positions intersecting the center axis line, wherein these through-holes are arranged in a straight line. The offset position of the cylindrical passage section 413f or the dimensions of the exhaust gas inlet side passage section 413d into the pipe connecting-hole on the side wall are adjusted to ensure that these through-holes for rotational shaft are arranged in a straight line.

One of method of such an arrangement of the through-holes is done as follows. For example, a rod is threaded through the through-holes to determine the positions of the two of the air intake passage and the EGR elbow passage member. Then the two are joined with each other by welding at an appropriate position of the connecting portion.

Alternatively, the shaft through-holes may be drilled after the two are joined to each other by welding at an appropriate position.

Thus, a rotational shaft 416S is threaded into the through-holes arranged in a straight line, and the butterfly valve 416A is fixed to the rotational shaft 416S by means of two screws 416m.

As shown in FIGS. 4 and 6, the rotational shaft 416S is rotatably supported by the two ball bearings 416J and 416K held at the portions of the through-holes provided on the side wall of the air intake passage. One end of the rotational shaft 416S is covered by a metallic cover, and the other end is further protruded from the ball bearing 416K. A resin collar 416U and the final-stage gear 416R are inserted through this protrusion. They are fixed on the rotational shaft 416S by means of nuts. A return spring 416M is set around the bearing boss with a bearing 416K, at the position between the resin color and the outer wall of the air intake pipe. One end of the return spring 416M is hooked to a stepped portion of the outer wall of the air intake passage so that the return spring does not move in the direction of rotation. The other end thereof is hooked with the resin collar 416U.

The resin collar 416U rotates together with the rotational shaft. When the control valve rotates in the direction of opening, the return spring is tightened so that a force of closing with respect to the control valve is applied.

The shaft through-holes provided on the cylindrical portion of the exhaust gas passage member don't only serve as holes through which the rotational shaft is threaded, but they serve as supporting member for preventing from producing unduly large stress which is applied to the ball bearings by the excessive warpage of the rotational shaft.

A motor casing is molded integrally with the air intake passage member.

The motor casing 416D houses a motor 416Dm so that the motor is attached to the air intake passage member.

A gear 416N is fixed on end side part of the rotational shaft of the motor 416Dm. A intermediate gear, which comprises a large-diameter gear 416P and a small-diameter gear 416Q formed integrally with each other by plastic molding, are rotatably supported by a stationary shaft 416T at the position between the final-stage gear 416R fixed to the rotational shaft 416S and the motor's-side gear 416N. The large-diameter gear 416p is meshed with the gear 416N.

The small-diameter gear 416Q is meshed with the final-stage gear 416R. The reduction ratio by this reduction gear mechanism is about one twentieth. This reduction ratio produces enough torque (about 100 kg) for rotating the control valve. Since this torque is very larger than the force of the return spring amounting to about 7 kg, it is capable of opening the control valve even when the control valve sticking to the passage's inner wall is caused by adhering of unburned products and tar contained in the exhaust gas. The sufficient force required for releasing the sticking on the circumference edge of the control valve is considered as about 20 through 30 kg. Therefore, the above-mentioned reduction torque can ensure a sufficient resistance to the valve sticking.

The exhaust gas taken in the air intake passage through the EGR elbow passage members (413d, 413e and 413f) is discharged into the center of the air intake passage 46 from the outlet 416f of the cylindrical passage section 413f, and is homogeneously mixed with the fresh air flowing in the surrounding.

According to this arrangement, since the exhaust gas is not brought into direct contact with the air intake passage member, increase of the temperature in the air intake passage member can be reduced.

The resin cover 416C is fixed at a predetermined position on the outer wall of the double-type pipe by screws 416h at four positions.

This resin cover covers the reduction gear mechanism and is provided with a sensor 416E for sensing the rotation angle of the rotational shaft 416S.

A connector is molded integrally together with the resin cover. This connector is provided with a terminal for outputting the rotational angle sensor signal of the rotational shaft to the outside, a terminal for supplying power to the motor from the outside; and a ground terminal.

One end of the rotational shaft 416S reaches up to inside of the resin cover 416c. The rotor 416L of the rotary sensor 416E is rotatably built into a flat portion of the resin cover 416C. The rotor 416L is provided with a brush 416X.

A lid 416E for covering a space formed in the resin cover is attached to the resin cover, and a board 416W having a surface perpendicular to the rotational shaft is mounted on the inside face of the lid 416E. A resistance conductor strip (not illustrated) is formed on the board at a position opposed to the brush 416X. The resistance conductor strip is electrically connected to the connector 416F via a terminal 416Y of the electric conductor formed integrally together with the resin cover 416C by insert molding. When the resin cover is attached to the outer wall of the air intake passage member, one end side part of the rotational shaft is inserted into a hole of the rotor 416L, and the rotor is fixed on the rotational shaft by a plate spring 416n. The brush 416X can rotate together with the rotor 416L by rotation of the rotational shaft 416S, and the change in the position of the brush 416X relative to the resistance conductor strip is output as an electric signal outside the device via connector 416F.

Thus, the actual opening of the EGR control valve 416A for controlling the opening of the EGR passage can be sensed. The sensing signal is reflected in the computation of control signal for the motor 416Dm for EGR.

The sensing signal for EGR passage-opening is sent to the engine control unit and is used therein for the computation of the opening target value (resultantly, a control signal for the motor 416Dm) of the EGR control valve 416A based on the EGR rate.

It should be noted that this sensing signal for EGR passage-opening may be sent to the control circuit 200 provided on the air intake control device; the same computation as the above-mentioned may be performed therein; and the control signal of the motor 416Dm as a target opening signal may be returned to the EGR control device.

The air intake control device 45 and the EGR control device 416 having been described so far are installed adjacent to each other.

To put it more specifically, the upper end of the EGR control device 416 is joined with the downstream end of the air intake control device 45. A gasket (or seal rubber) 45E is sandwiched in-between, and is fixed by the bolts 45G. The bolts 45G join an upper flange 45C, a lower flange 45F of the air intake control device and a flange 416H of the EGR control device 416, through the four bolt holes 45D provided around the air intake passage member at a predetermined interval.

In this case, the throttle rotational shaft 3 and the EGR rotational shaft 416S are arranged in parallel with each other. The EGR valve opening where a greater flow rate of the exhaust gas flows into the air intake passage 46 from the cylindrical passage section 413f conforms to the direction where the opening of the air intake control valve is the greatest. Thereby smooth mixing between fresh air and exhaust gas, and uniform distribution of exhaust gas to respective cylinders are executed.

The resin covers 9 and 416C of the two are located on the same side on the air intake passage member. According to this arrangement, cable connecting working at respective connectors is carried out on the same side, and therefore ensures excellent workability. Further, this arrangement is preferable when ensuring a space for installing a cooling apparatus to be described later.

In the device characterized by the aforementioned advantages, the motor casings for throttle and EGR as well as the rotational shafts are arranged in parallel. The motor rotational shaft is also placed in parallel with those rotational shafts for throttle and EGR.

The present embodiment having the aforementioned structures provides the following advantages.

The cooling apparatus 414 is used for cooling the exhaust gas by heat exchange carried out between engine cooling water and exhaust gas. The cooling water enters the cooling apparatus from an inlet header 414A and flows through the passage provided with a corrugated fin 414a of FIG. 4, and then discharged from a cooling water outlet header 414B.

The exhaust gas is led from an inlet header 413A, flows through parallel passages of the heat exchange in the arrow-marked direction, and is collected into an outlet header 413b. After that, the exhaust gas is led to the exhaust gas inlet side passage section 413d through the outlet header 413b.

In this case, the exhaust gas at a temperature of 500° C. is heat-exchanged with the engine cooling water at a temperature of 100° C. at the inlet of the cooling apparatus, whereby temperature at the inlet is reduced to 200° C. This allows the exhaust gas to be led directly to the center of the air intake passage member.

An exhaust gas flow rate sensor 415 (156) is provided at the connection passage 413d of the cooling apparatus outlet and senses the flow rate of the cooled exhaust gas. This arrangement reduces a change in gas temperature, and hence increases the measuring accuracy.

Further, gas density can be increased (with reduced volume) by lowering the EGR gas temperature, and the upper limit of the recirculation rate can be enhanced, thereby reducing the amount of nitrogen oxides (NOx). Further, the engine combustion time can be reduced by the reduced gas temperature.

The reference numeral 413g indicates screws and screw holes for jointing the EGR pipe to the connecting opening portion 413k of the air intake passage.

In the above description of the embodiment, the elbow passage member of the exhaust gas recirculation control device 416 is formed as a separate body and is assembled inside the air intake passage member. The following procedure allows them to be formed as an integral single body by molding.

In FIG. 2, if molds for forming the double-pipe type passage member with the elbow passage member of the exhaust gas recirculation control device 416 are designed under the following consideration, the double-pipe type passage member can be molded in a single-piece design. That is, the molds are separated under consideration of an outside curved part of the elbow passage member and an inside curved part thereof; those molds are so designed as to be capable of separating into directions of upstream side and downstream side; a third mold is so provided as to be capable of extracting on the right hand side of FIG. 2.

Referring to FIG. 7, the following describes the details of the resin cover of the air intake control device side.

Terminals 5A of the motor 5 are electrically connected to terminals 14 provided at the resin cover 9. In the present embodiment, terminals 14 insert-molded with the resin cover 9 are also male terminals as well as motor terminals. Accordingly, a terminal joint 5B having female terminals on both sides are interposed between male terminals 5A on the motor side and male terminals 14 on the cover side.

Conductors continuing to the terminals 14 are electrically connected to bonding pads on one side of the control circuit board 200 via bonding wires 202 whose one ends are brazed to the bonding pads. An aluminum-made heat sink 200A is sandwiched between the control circuit board 200 and an inner wall surface of the resin cover. Another side of the control circuit board is provided with a group of terminals which are electrically connected to throttle position sensor 10 through bonding wires 201. One ends of the terminals are soldered to the bonding pad. One ends of electric conductors 10w are connected to the resistance board of the sensor and the other ends are connected to the bonding wire 201.

A partition (hereinafter referred to as “control unit cover” in some cases) 12 isolates the control circuit board from the gear housing space. The partition 12 does not only prevent the control circuit board from contamination but also prevents the intermediate gear 7 from breaking away in the thrust direction.

A sensor cover 10c is provided with a boss for supporting a rotor 10R for the sensor. A part on one end side of rotational shaft is inserted into the center hole of the rotor. The rotor is fixed to the rotational shaft by means of a C-ring 10P.

A sealing gum 10d seals a gap between the rotor 10R and sensor cover 10c.

A hardware 4c served as a seal holder for a lip seal 4d. This lip seal ensures that the exhaust gas components resulting from blowing off of the exhaust gas do not enter the sensor chamber or control circuit chamber.

The following summarizes the aforementioned advantages of the present embodiment.

(1) The control valve can be opened with enough force even when there is an abrupt change of air intake in the transition mode at the time of acceleration and deceleration. This ensures a quicker response (about 100 ms from fully close to full opening) and shorter time to reach the target recirculation rate.

(2) The conventional method of taking in the EGR gas from the side surface of the air intake passage has been characterized by Lack of uniformity in the gas distribution. In the present invention, by contrast, the EGR gas is led to the center of the air intake passage. This arrangement provides excellent mixing and suitable cylinder distribution.

(3) The cooling effect by the cooling apparatus is demonstrated by the temperature reduced to 500° C. at the EGR inlet and 200° C. at the EGR outlet, with the result that a change in gas temperature is minimized. This ensures improved EGR measuring accuracy. Further, EGR gas density can be increased (with reduced volume) by lowering the EGR gas temperature, and the upper limit of the EGR rate can be enhanced, thereby reducing the amount of nitrogen oxides (NOx). The engine combustion time can be reduced by the reduced gas temperature, with the result that the amount of nitrogen oxides (NOx) is further reduced.

(4) According to the conventional method, the EGR gas has been brought in direct contact with the air intake passage member at the inlet of the air intake passage. By contrast, the exhaust gas is led into the air intake passage along the air intake passage in the present embodiment. Accordingly, the air intake passage member proper is not heated directly by the exhaust gas.

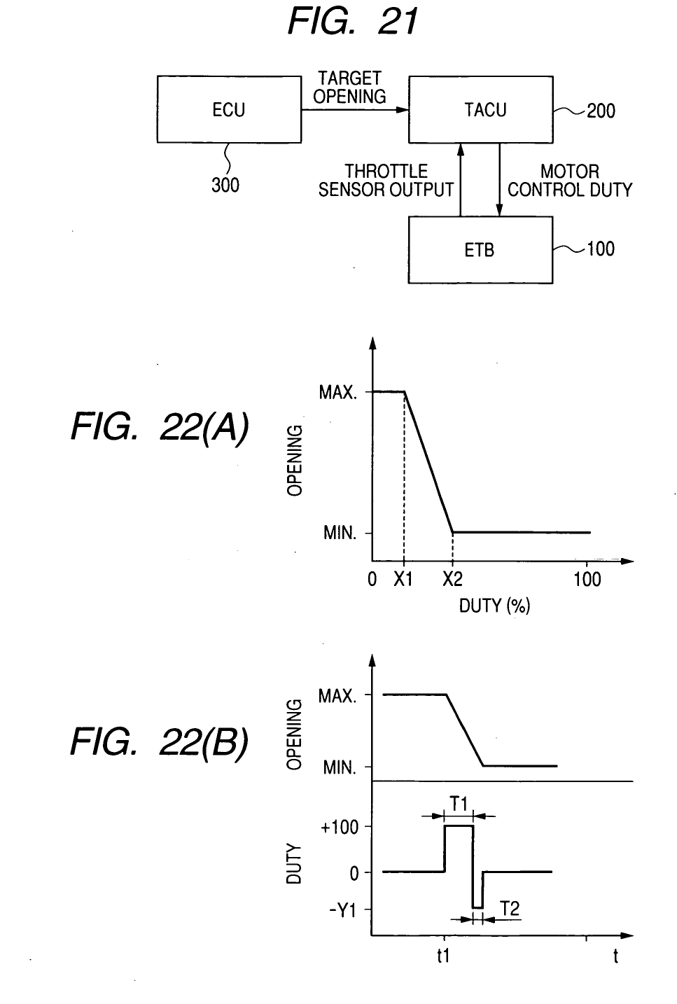

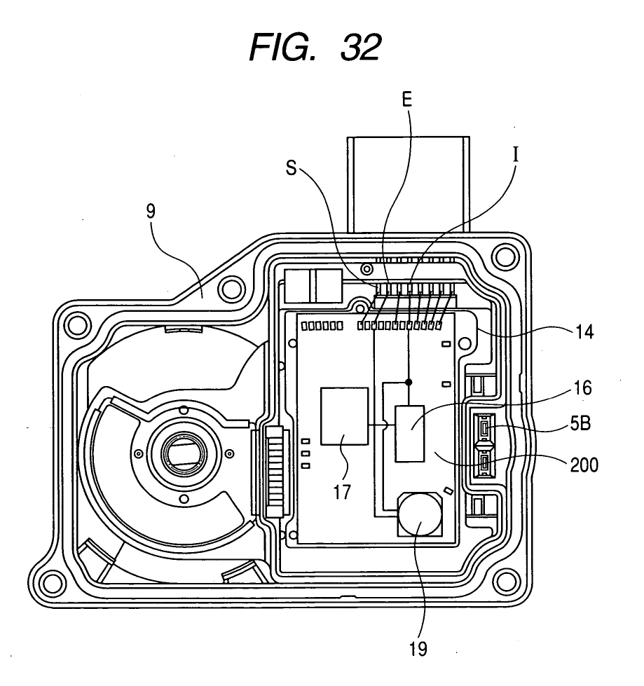

Referring to FIGS. 21 through 35, the following describes the portion of the electronically controlled throttle device of the diesel engine according to the present invention.

In the first place, the system configuration of the electronically controlled throttle device of the present embodiment will be described with reference to FIG. 21.

FIG. 21 is a schematic diagram representing the system configuration of the electronically controlled throttle device as a first embodiment of the present invention.

The electronically controlled throttle device as the present embodiment comprises an electronic throttle body (ETB) 100 and a throttle actuator control unit (TACU) 200. The electronic throttle body (ETB) 100 is equipped with a throttle valve rotatably supported in the throttle body, and an actuator such as a motor for driving this throttle valve. The details of the arrangement will be described later with reference to FIGS. 24 through 31.

The throttle actuator control unit (TACU) 200 controls the opening of the throttle valve in the electronic throttle body (ETB) 100 so that the actual opening thereof reaches the target opening provided by the engine control unit ECU 300. In response to the target opening given by the ECU 300, the TACU 200 outputs to the ETB 100 the motor control duty signal for allowing the throttle valve of the ETB 100 to be rotated. The opening of the throttle valve rotated by this duty signal is sensed by the throttle position sensor and is supplied to the TACU 200 as a throttle sensor output. Under the normal control, the TACU 200 carried out feedback control of the throttle valve opening so that the throttle sensor output reaches the target opening. The structure and operation of the TACU 200 will be described later with reference to FIGS. 24 through 31.

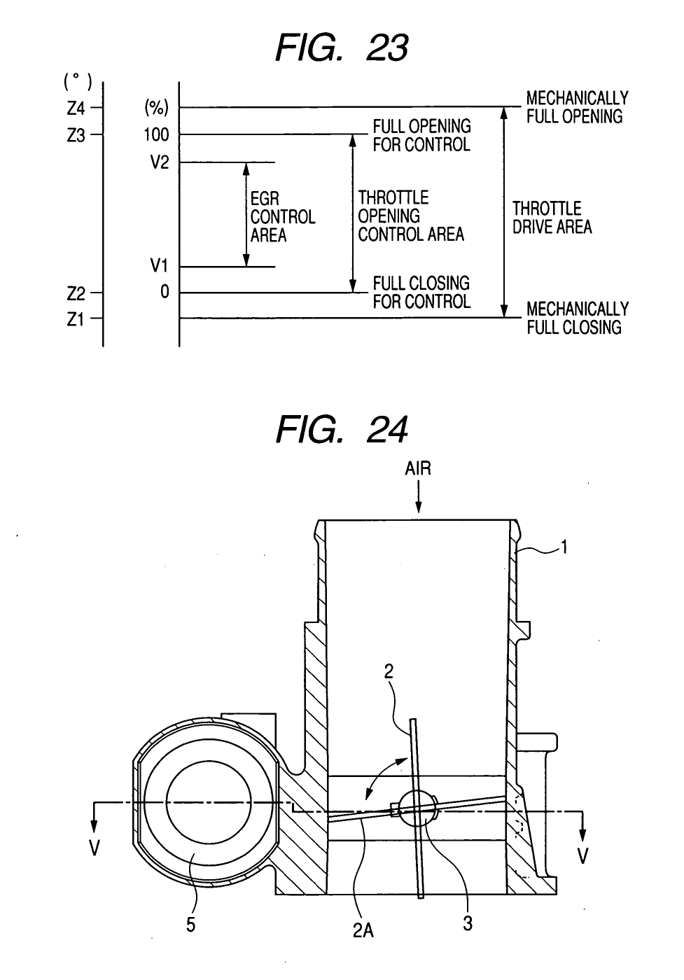

The following describes opening characteristics in the electronically controlled throttle device of the present embodiment, with reference to FIGS. 22 and 23.

FIG. 22 is an explanatory view representing the opening characteristics of the throttle valve in the electronically controlled throttle device as a first embodiment of the present invention. FIG. 22 (A) is an explanatory view representing the static characteristics of the throttle valve opening. FIG. 22 (B) is an explanatory view representing the dynamic characteristics of the throttle valve opening.

In the first place, the static characteristics of the opening of the throttle valve will be described with reference to FIG. 22 (A). In FIG. 22 (A), the horizontal axis represents duty of the motor control duty signal supplied to the ETB 100. The vertical axis indicates the throttle valve opening. The throttle valve is exerted in the direction of opening by a return spring, as will be described later. Such being the case, when the duty is 0%, namely, when the no current is supplied to the motor, the throttle valve is returned in the direction of opening, and hence the throttle valve is maximally opened.

When the duty signal is in the range from 0 through X1%, a drive force occurs to the motor, but the force is smaller than the return spring's exerting force for throttle valve. Thus, the throttle valve is kept at the maximally opened position. When the duty signal has been increased to X1% through X2%, the motor drive force overcomes the return spring's exerting spring. Therefore the throttle valve opening is gradually reduced toward the minimum level. When the duty becomes X2%, the throttle valve opening reaches the minimum level. If the duty has exceeded X2%, the throttle valve opening is kept at the minimum. The values for duty X1% and X2% vary according to the exerting force of the return spring and the drive force generated by the motor. For example, X1%=15% and X2%=30%. Such being the case, when the motor control signal having a duty of 22.5% (=(15+30)/2) has been applied to the motor, the opening of the throttle valve is kept at some mid-position between the maximum and minimum levels.

The above description indicates a static relationship between the duty signal and the throttle valve opening. In the meantime, when the throttle valve is changed from one opening to another, the dynamic characteristic shown in FIG. 22 (B) is used. The horizontal axis of FIG. 22 (B) indicates time. The vertical axis on the upper side indicates the throttle valve opening, while the vertical axis on the lower side indicates the duty. For example, when the opening of the throttle valve is changed from the maximum to the minimum level, as shown in the upper portion of FIG. 22 (B), the signal of 100% duty is output for a time duration of T1 at time t1, as shown in the lower portion of FIG. 22 (B). Immediately thereafter, the throttle valve opening is changed from the maximum to the minimum. After the lapse of time duration T1, the signal of −Y1% duty is output for time duration T2. In this case, the duty has a negative symbol. This signifies that the direction of the current supplied to the motor is the reverse, and the motor is provided with rotational torque in the reverse direction. To be more specific, when a signal of 100% duty is supplied, the high-speed motor driving operation is performed in the direction of the throttle valve minimum opening, and after the lapse of time T1, the motor is applied with brakes by rotational torque in the reverse direction. Thereby, the throttle valve's quick approach for the target opening is carried out. After that, feedback control is implemented by controlling the duty signal so that the valve opening signal output from the throttle position sensor reaches the target opening. The specific values for times T1 and T2 and −Y1% differs according to the control system. For example, T1=30 through 50 ms, −Y1=−100%, and T2=3 through 6 ms, when the opening is changed from the maximum to the minimum in a response time of 100 ms. The values for the T1, T2 and Y1 are obtained by PID computation. They depend on the control constant of the PID computation.

Referring to FIG. 23, the following describes the definition of the opening of the throttle valve in an electronically controlled throttle device of the present invention.

FIG. 23 is an explanatory diagram defining the opening of the throttle valve in the electronically controlled throttle device in the first form of embodiment of the present invention.

The throttle valve opening includes two types such as a control opening and a mechanical opening. The opening described with reference to FIG. 22 belongs to the control opening. The control opening is to be controlled by the TACU 200. Here the minimum through maximum opening ranges from 0 through 100%, for example. 0% indicates that the throttle valve is controlled at a full closing position within control range, while 100% indicates that the throttle valve is controlled at a full opening position within control range. The range from 0 through 100% is referred to as a throttle valve opening control range.

In the meantime, the ETB 100 is provided with two stoppers for mechanically restricting the opening of the throttle valve. The mechanically full closing position is where the throttle valve is stopped with a stopper on the minimum side. The mechanically full opening position is where the throttle valve is stopped with a stopper on the maximum side. The range from the mechanically full opening position to the mechanically full closing position is called as a throttle valve rotation range. The throttle valve rotation range is wider than the throttle valve opening control range, as shown in FIG. 23.

The following describes an example of openings represented in terms of physical angles. Assume that the angle where the throttle valve is perpendicular to the flow direction of air is 0 degree. For example, the mechanically fully close position Z1 corresponds to 6.5 degrees, and the mechanically full closing position Z2 corresponds to 7 degrees. The mechanically full opening position Z3 corresponds to 90 degrees, and the mechanically full opening position Z4 corresponds to 93.0 degrees.

As shown in FIG. 23, the throttle valve opening control range includes the EGR control or DPF control range (V1 through V2). To be more specific, when the target opening provided by the ECU 300 to the TACU 200 is within the range from V1 through V2, the TACU 200 can determine to be under the EGR control or DPF control. For example, the V1 is 10% and V2 is 80% within the control range (0 through 100%).

Referring to FIGS. 24 through 31, the following describes the structure of the electronically controlled throttle device of the present embodiment.

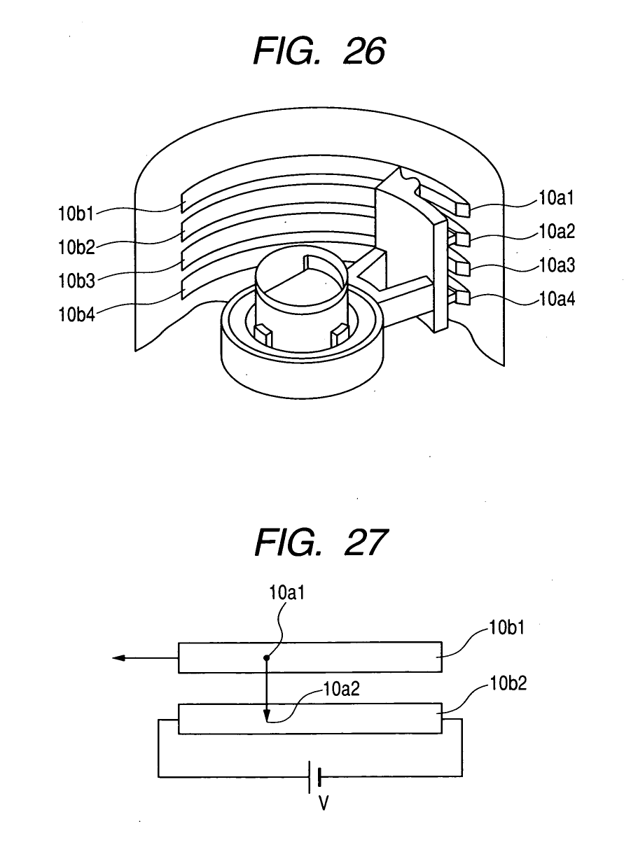

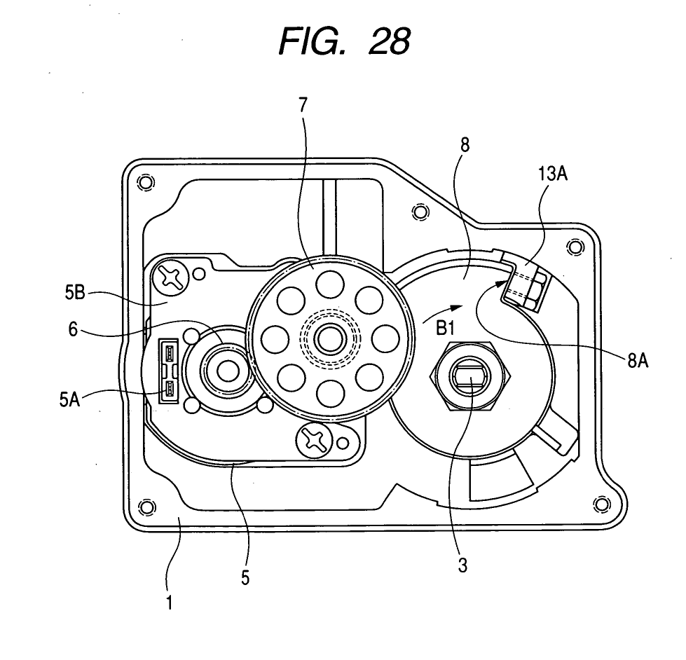

FIG. 24 is a vertical sectional view of the first form of embodiment in the present invention. FIG. 25 is a sectional view as seen in the direction of arrow V-V of FIG. 4. FIG. 26 is a perspective view showing the throttle position sensor used in the electronically controlled throttle device of the first form of embodiment in the present invention. FIG. 27 is a circuit diagram showing the throttle position sensor used in the electronically controlled throttle device of the first form of embodiment in the present invention. FIGS. 28, 29 and 30 are views as seen in the direction of the arrow A in FIG. 24 wherein the gear cover is removed. FIG. 31 is a plan showing the gear cover used in the aforementioned electronically controlled throttle device in one form of embodiment. It should be noted that the same reference numerals in the drawings indicate identical components.

As shown in FIG. 24, the throttle body 1 forms an air passage and supports various components. In the air passage, the intake air flows downward in the direction marked by arrow AIR. The throttle body 1 is produced by an aluminum die-casting machine, for example. The throttle valve 2 is fixed to the throttle shaft 3 by screws and others. The throttle shaft 3 is supported rotatably by ball bearings in the throttle body 1. Where a duty signal is not applied to the motor as shown in the drawing, the throttle valve 2 is kept at the mechanically full opening position by the exerting force of the return spring. A DC motor 5 is incorporated inside the throttle body 1, and is fixed thereon. The drive force of the DC motor 5 is transmitted to the throttle shaft 3 through a gear (not illustrated), thereby rotating the throttle valve 2.

As shown in FIG. 25, the throttle shaft 3 is supported by the ball bearings 4a and 4b rotatably in the throttle body 1. A gear 8 is fixed to the throttle shaft 3. A return spring 11 is provided between the gear 8 and throttle body 1. The return spring 11 exerts a spring force on the gear 8 and throttle shaft 3 so that the throttle valve 2 moves in the full opening direction.

The DC motor 5 is incorporated inside the throttle body 1, and is fixed thereon. A gear 6 is fixed to an output shaft of the DC motor 5. The gear 7 is supported rotatably about the shaft 7A fixed to the throttle body 1. Gears 6, 7 and 8 are meshed with each other and the drive force of the motor 5 is transmitted to the throttle shaft 3 through the gears 6, 7 and 8. Rotation of the throttle valve 2 electronically controls the flow rate of air intake into the engine.

The gear cover 9 is provided with the throttle actuator control unit (TACU) 200. A control unit cover 12 is fixed to the gear cover 9 to prevent deposition of water on the TACU 200. The gear cover 9 is formed by plastic molding, and connector terminals 14 are provided to the gear cover by insert-molding. One ends of the connector terminals 14 are electrically connected with the TACU 200. When the gear cover 9 is mounted on the throttle body 1, the other ends of the connector terminals is engaged with the motor terminal of the motor 5. Thus, the TACU 200 and motor 5 are electrically connected with each other. When a duty signal is applied to the motor 5 from the TACU 200, the DC motor 5 generates rotational torque.

The throttle position sensor 10 for sensing the position of the throttle valve 2 comprises a brush 10a as a component on the movable side and a resistor 10b as a component on the fixed side. When the brush 10a is fitted with the throttle shaft 3, it is rigidly fixed with the throttle valve 2. The resistor 10b is mounted inside the gear cover 9. When the brush 10a has brought in contact with the resistor 10b, the position of the throttle valve 2 is converted into voltage, which is then outputted to the control unit 12.

Referring to FIGS. 26 and 27, the following describes the structure of the throttle position sensor 10. As shown in FIG. 26, the throttle position sensor 10 is composed of four brushes 10a1, 10a2, 10a3 and 10a4, and four resistors 10b1, 10b2, 10b3 and 10b4. The first throttle position sensor is formed of the brushes 10a1 and 10a2 and resistors 10b1 and 10b2, and the second throttle position sensor is formed of the brushes 10a3 and 10a4 and resistors 10b3 and 10b4. Although the diesel engine system of the present embodiment has the above-mentioned two system throttle position sensors which are generally used for gasoline engine system, the diesel engine system is arranged so that only one of the two-system throttle position sensors is used for the diesel engine.

As shown in FIG. 27, in one of the throttle position sensors, the brushes 10a1 and 10a2 are kept in contact with slidable along the resistors 10b1 and 10b2. A DC voltage from a power supply is applied across the resistor 10b2. When voltage is detected through the resistor 10b1, the position of the brush 10a, namely, the position of the throttle valve 2 is detected as a voltage signal.

Under normal control, the TACU 200 uses the output of the throttle position sensor 10 and implements the feedback control to ensure that the position of the throttle valve 2 reaches to the target opening.

A washer 150 is provided between the gear 7 and the throttle body 1. The washer 15 is made of the wear resistant plastic material, e.g. molybdenum-containing PA66 nylon. When power is not supplied to the motor 5, the drive force is not produced by the motor 5. In this case, the throttle valve 2 is held at the mechanically full opening position by the return spring 11. The gears 6 and 8 are rigidly fixed to the motor shaft and throttle shaft 3. The gear 7 is mounted freely on the shaft 7A. Since the throttle control device of the present embodiment is mounted on a vehicle, if the gear 7 is free, its arrangement risks occurring vibration of the gear 7 in the thrust direction of the shaft 7A by vibration of the vehicle, thereby incurs the risk of hitting of the end surface of the gear 7 against the throttle body 1. This will produce abnormal noise and will cause a damage and wear of the throttle body 1. Incidentally, the throttle body 1 is made of aluminum diecast material, while the gear is made of the sintered alloy having a higher strength than aluminum. To prevent abnormal noise or damage from occurring, a washer 15 composed of a wear resistant plastic material is used.

FIG. 28 is a view as seen in the direction of the arrow A in FIG. 25 wherein the gear cover 9 is removed. The motor 5 is fixed on the throttle body 1 by screwing a motor mounting plate 5B on the throttle body. Power supply terminals 5A of the motor 5 protrude from the through of the plate 5B.

The throttle body 1 is provided with a mechanically full closing stopper 13A in the vicinity of the gear 9. When the motor 5 is supplied with a 100%-duty signal, the gear 8 rotates in the arrow-marked direction (in the direction as the throttle valve 2 closes). Thereby, the stopper end 8A formed on the gear 8 is receive with the mechanically full closing stopper 13A, and the throttle valve is kept at the mechanically full closing position.

Immediately when the control unit 12 has detected any failure in the DC motor 5 and the throttle position sensor 10, the electronically controlled throttle device for the diesel engine cuts off the power of the DC motor 5 or locks the control duty at 0%, and the throttle valve is moved back to the mechanically full opening position 13B only by spring force of the return spring 11.

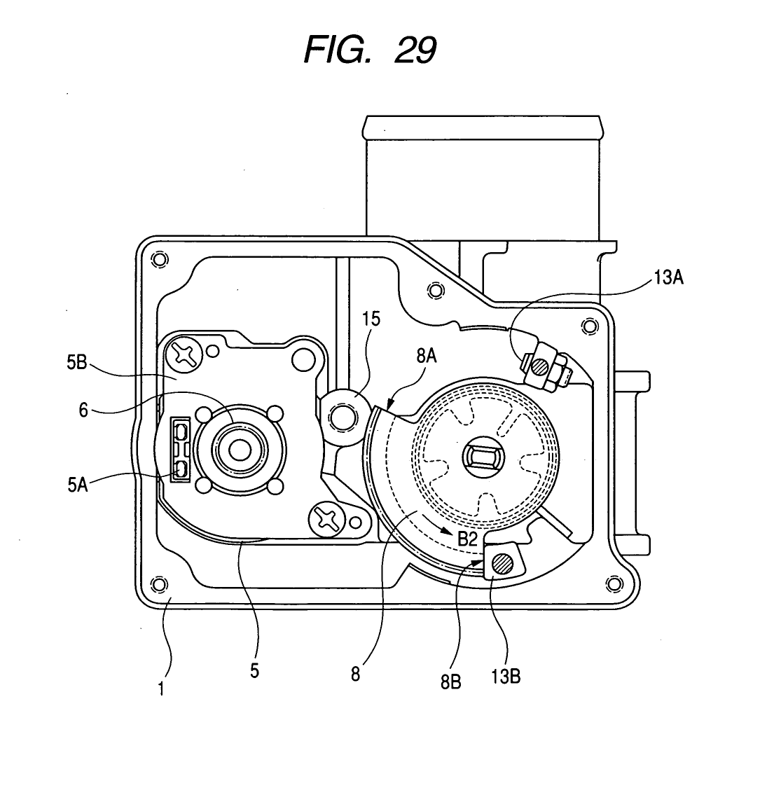

FIG. 29 is the same as FIG. 28, except that the gear 7 is removed in FIG. 29. The gear 8 is an ark-shaped gear of about one-third form of a circle. One side of the gear serves as a stopper end 8A, while the other side serves as a stopper end 8B. The throttle body 1 is provided with the mechanically full opening stopper in the vicinity of the gear 9. When the motor 5 is not supplied with duty signal or voltage, the stopper end 8B is received with the mechanically full opening stopper 13B by the return spring 11 exerting in the direction of opening. The throttle valve 2 is located at the mechanically full opening position. To be more specific, when the motor 5 is not supplied with duty signal, the throttle valve 2 is kept at the mechanically full opening position.

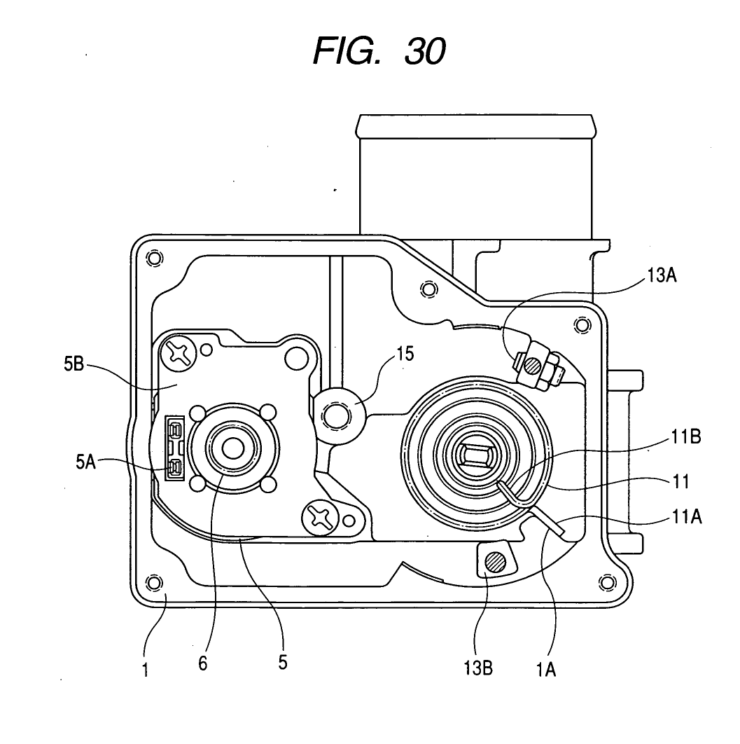

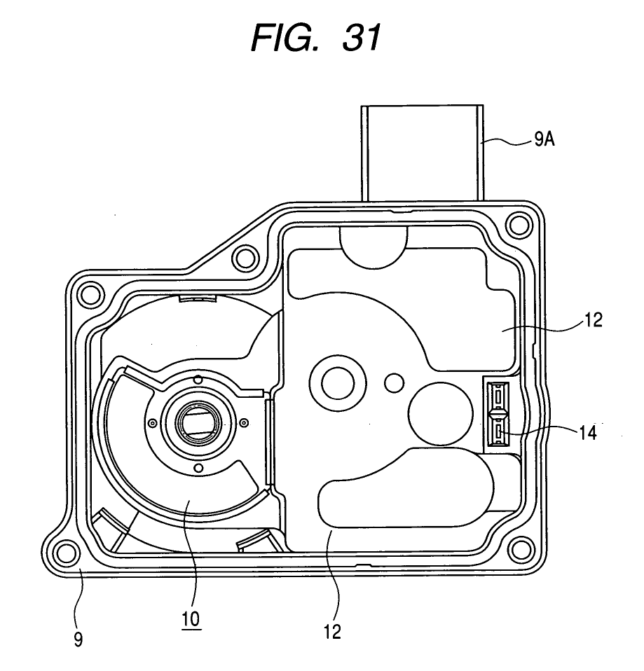

FIG. 30 is the same as FIG. 29, except that the gear 8 is removed in FIG. 29. Only one return spring 11 is used. One end 11A of the return spring 11 is hooked with a part 1A of the throttle body 1, and the other end 11B is hooked with the gear 8 so that the throttle valve 2 is exerted in the valve opening direction.

FIG. 31 is a plan showing the gear cover 9. The gear cover 9 is provided with connector terminals 14. The gear cover 9 is provided with a connector 9A for connection with the ECU 300 and external power supply. The internal terminals are connected to the TACU 200.

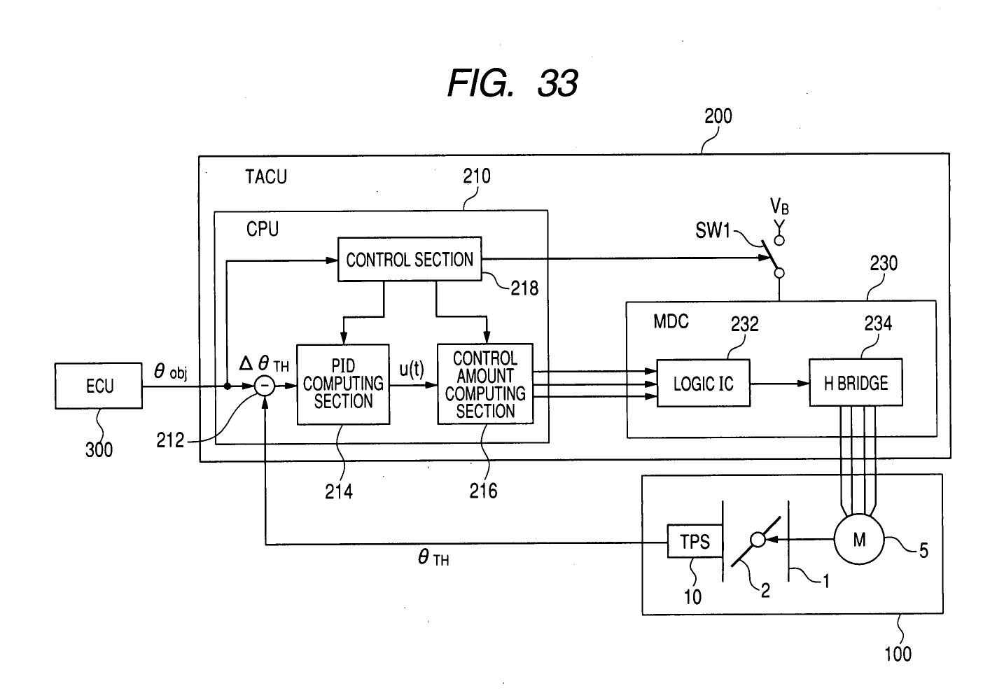

Referring to FIG. 33, the following describes the system configuration of the throttle actuator control unit (TACU) 200 of the electronically controlled throttle device of the present embodiment.

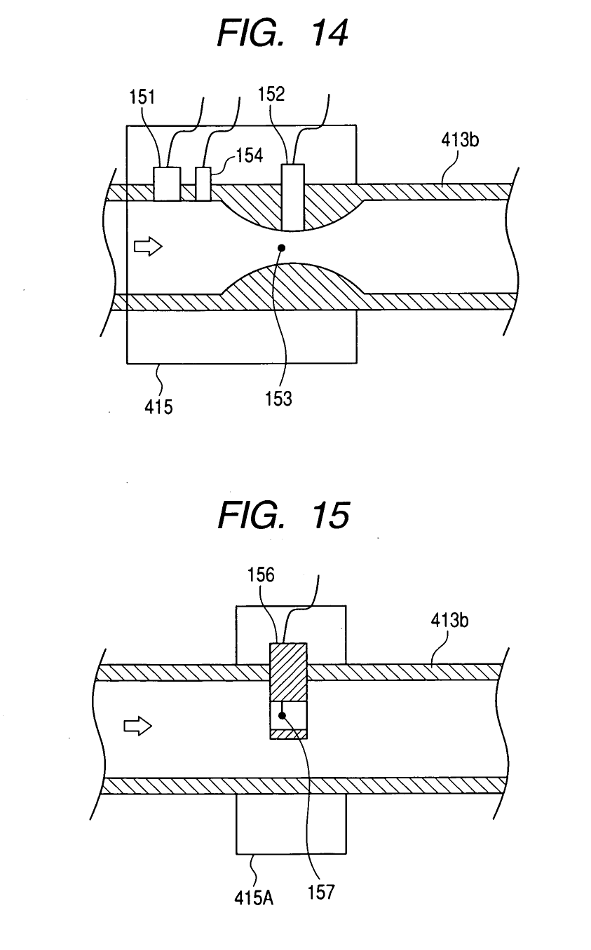

FIG. 33 is a schematic diagram representing the system configuration of the throttle actuator control unit (TACU) in the electronically controlled throttle device used in the present invention as the first form of embodiment of the present invention. It should be noted that the same reference numerals in FIGS. 21, 14 and 25 indicate identical components.

The throttle actuator control unit (TACU) 200 comprises a CPU 210 and a motor drive circuit (MDC) 230. The CPU 210 is made of a difference computation section 212, a PID computation section 214, a control amount computation section 216 and a control section 218.

The difference computation section 212 computes the opening difference Δth between the target throttle valve opening θobj outputted from the ECU 300 and the actual throttle valve opening θth outputted from the throttle position sensor 10. Based on the opening difference Δθth outputted by the difference computation section 212, the PID computation section 214 computes the PID control amount u(t). The PID control amount u(t) obtained from the PID computation can be obtained as the (Kp*Δθth+Kd*(dΔθth/dt)+Ki*ΣΔθth*dt). Here, Kp is a proportional constant, Kd is a differential constant, and Ki is a integral constant. Based on the PID control amount u(t), the control amount computation section 216 selects the on/off switch of the H-bridge circuit 234 and determines the direction where the current is supplied. It also determines the duty for turning on or off the switch of the H-bridge circuit 234, and the result is outputted as a control amount signal. As shown in FIG. 35, based on the target opening θth, the control section 218 determines if the EGR or DPF control is performed or not. If neither EGR or DPF control is performed, the control section 218 executes the control to full opening the throttle valve, and, if required, provides the on/off control of the switch SW1 for supplying voltage VB to the PID computation section 214, the control amount computation section 216 or motor drive circuit (MDC) 230.

The MDC 230 comprises a logic IC 232 and a H bridge circuit 234. Based on the control amount signal outputted by the control amount computation section 216, the logic IC 232 outputs on/off signal to the four switches of the H bridge circuit 234. In response to the on/off signal, the switches of the H bridge circuit 234 are on/off-controlled, thereby the required current is supplied to the motor 5 so that the motor 5 can be turned in the forward or backward direction.

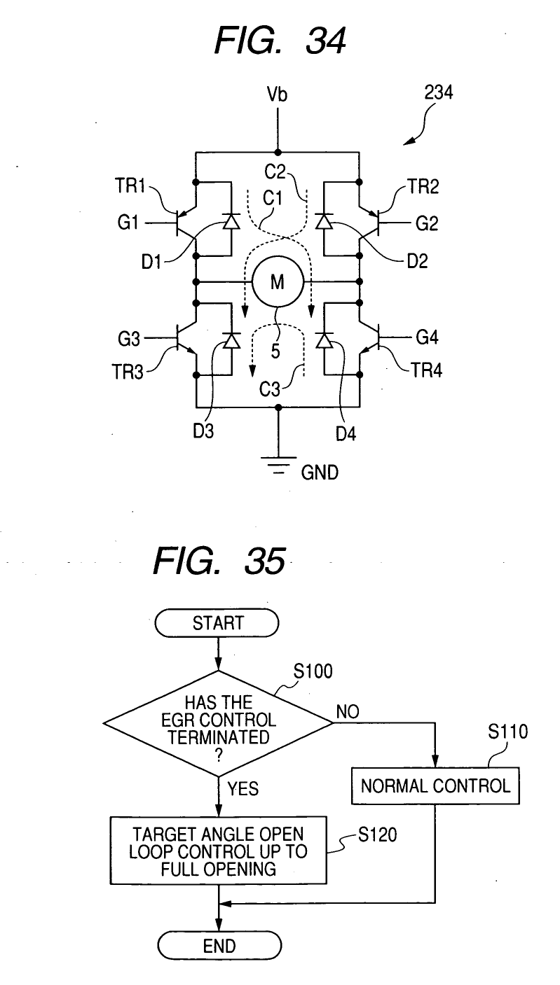

The following describes the structure of the H bridge circuit 234 used in the electronically controlled throttle device of the present embodiment with reference to FIG. 34.

FIG. 34 is a circuit diagram showing the H bridge circuit used in the electronically controlled throttle device in the first form of embodiment of the present invention.

The H bridge circuit 234 comprises four transistors TR1, TR2, TR3 and TR4 and four diodes D1, D2, D3 and D4 connected as shown in FIG. 34, whereby a current is supplied to the motor 5. For example, when the gate signals G1 and G4 go high to and the transistors TR1 and TR4 are turned on, then the current flows as indicated by the broken line C1. In this case, for example, the motor 5 makes a forward rotation. When the gate signals G2 and G3 go high to and the transistors TR2 and TR3 are turned on, then the current flows as indicated by the one-dot chain line C2. In this case, for example, the motor 5 makes a reverse rotation. When the gate signals G3 and G4 go high to and the transistors TR3 and TR4 are turned on, then the current flows as indicated by the two-dot chain line C3. In this case, a drive force is transmitted to the drive shaft of the motor from the outside and regenerative braking operation can be performed. It should be noted that regenerative braking of the motor 5 can be performed even if the transistors TR1 and TR2 are turned on simultaneously.

The present embodiment employs the one-chip microcomputer wherein the bridge circuit is integrated. It is also possible to apply the digital signal to the logic IC and to perform a free on/off control operation of the transistor. Since the above-mentioned operation mode can be achieved by controlling the motor drive circuit, the H bridge per se may be constituted with four transistors independent of the IC-chip or may be incorporated in the above-mentioned integrated one-chip IC.

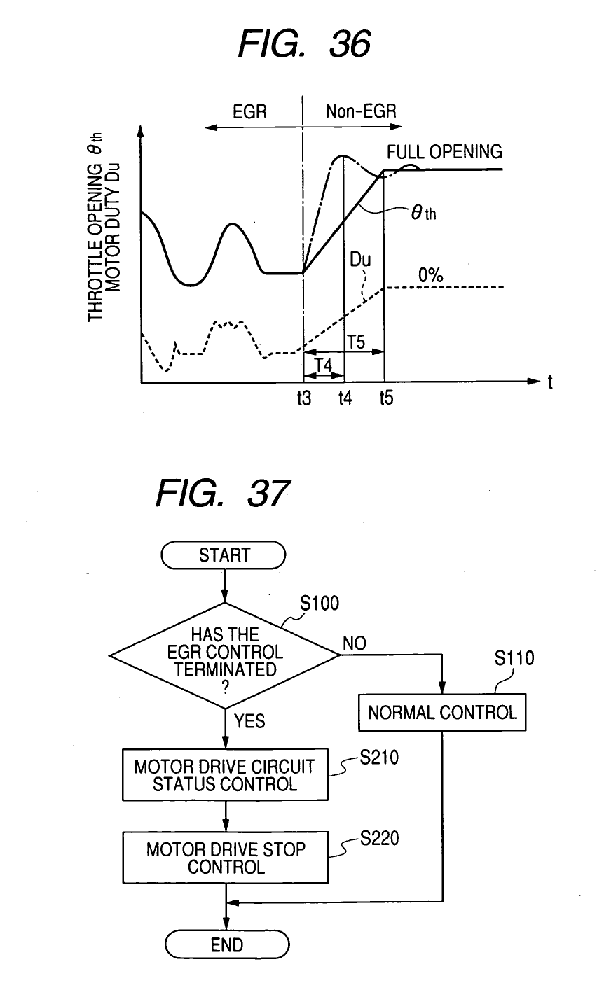

The following describes the control operation by the control section 218 of the electronically controlled throttle device of the present embodiment with reference to FIGS. 35 and 36.

FIG. 35 is a flow chart showing the specific control items of the control section in the electronically controlled throttle device as the first form of embodiment of the present invention. FIG. 36 is an explanatory view showing the specific control items of the control section in the electronically controlled throttle device as the first form of embodiment of the present invention.

In the Step S100, the control section 218 decides if the EGR control or DPF control has terminated or not. If the control is not yet terminated, the normal feedback control is continued in the Step S110. If the control has been terminated, the target angle control up to the full throttle valve open is performed in the Step S120.

In the decision of the Step S100, the control section 218 uses the target throttle valve opening having been inputted from the ECU 300 to see if the EGR or DPF control has terminated or not. For example, if the throttle valve opening control range is 0 through 100%, the range (V1 through V2) (e.g. 10 through 80%) is the EGR or DPF control range, as described above with reference to FIG. 23. Such being the case, if the target opening inputted from the ECU 300 is in the range from 10 through 80%, the control section 218 decides as placed under the EGR or DPF control. If the target opening is 0 through 10%, it decides that they have been terminated. In the case of 80 through 100%, it may be also possible to arrange such a configuration that the control section 218 checks whether or not a EGR or DPF control termination flag has been received from the ECU 300.

Referring to FIG. 36, the following describes the target angle control up to the full opening in the Step S120. In FIG. 36, the horizontal axis represents time t. The vertical axis indicates the throttle valve opening (control) angle θth and motor duty Du. For the throttle valve opening θth, the position closer to the full closing position is located closer to the origin, while the position closer to the full opening position is farther from the origin. The motor duty Du closer to 100% is located closer to the origin, while the motor duty Du closer to 0% is located farther from the origin.

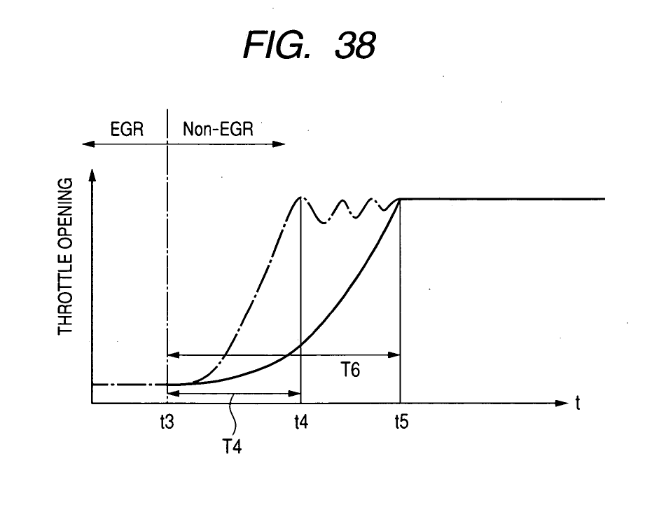

In FIG. 38, the solid line θth indicates a change in the throttle valve opening, and the broken line Du indicates the duty applied to the motor. The time up to the t3 denotes the time duration when the EGR or DPF control is carried out. After the time t3, the EGR or DPF control is terminated. After the time t3, the solid line θth indicates a change in the throttle valve opening when the control according to the present embodiment has been performed. The one-dot chain line indicates a change in the throttle valve opening when the control according to the present embodiment has not yet been performed.

Up to time t3, the EGR or DPF control is performed by the processing in the Step S110. The duty Du applied to the motor changes in response to the target opening θobj inputted from the ECU 300, and the throttle valve opening θth also changes, accordingly.

If the EGR or DPF control has been determined to have terminated at time t3, the power supply to the motor will be discontinued when the control according to the present embodiment is not performed. To be more specific, the duty is reduced to 0%. Such being the case, the throttle valve is moved to the full opening side by spring force of the return spring, as indicated by the one-dot chain line. The throttle valve is received with the full closing stopper at time t4, and the process of rebounding from the stopper and pulling back by the return spring is repeated, after that the throttle valve will be ultimately stopped at the controlled full opening position. The time duration T4 from time t3 through t4 is 150 ms, for example. If the throttle valve is pulled back by the return spring at such a high speed, it collides with the full opening stopper. This will result in generation of collision noise and a reduced service life of the mechanical parts due to impact load.

In the meantime, a detailed explanation of opening loop control of the target rotation angle for the throttle valve is given as follows. The control section 218 allows the duty to be gradually reduced from the level at the time (time t3) when the EGR or DPF control is determined to have terminated, as shown by the duty Du applied to the motor. Then the control signal producing a duty of 0% at time t5 is outputted to the control amount computation section 216. The control amount computation section 216 gradually reduces the duty from time t3 and outputs the control signal producing a duty of 0% at time t5 to the logic IC 232. As a result, the motor is driven in response to the duty signal given by the broken line in the drawing. Thus, the throttle valve opening θth is gradually moves to the full opening side from the opening at the time (time t3) when the EGR or DPF control is determined to have terminated, as shown by the solid line of the drawing. Then the full opening point is reached at time t5. In this case, the duty is gradually reduced to ensure that the time duration T5 from time t3 through t5 will be 500 ms, for example. This procedure reduces the speed at the time of collision between the gear 8 and full opening stopper 13A when the throttle valve is pulled back to the full opening point, thereby avoiding possible generation of collision noise and possible reduction in the service life of the mechanical parts due to impact load.

As can been seen from the above description, if the motor drive duty under the open loop control is given in such a way that the response speed will be slower than when returned only by the spring force given in the direction of full opening (T4<T5), it is possible to reduce the noise of collision between the full opening stopper and the gear of the motor drive system and the impact energy. Incidentally, as described in the Japanese Application Patent Laid-open Publication No. 2003-214196, if a predetermined control value set in advance is applied to the motor for a given period of time, variations in the response time between individual productions cannot be absorbed. Accordingly, the motor drive control may continue even if the throttle valve has come back to the full opening position. This may cause the motor to be damaged by overcurrent. By contrast, the method according to the present invention solves the problem of continued control even after return to the full opening stopper position.

The control section 218 controls the throttle valve opening by using the open loop control system where the target duty is given. In this case, the duty in the open loop control can be given in terms of a monotone decreasing linear expression, as shown in FIG. 36. Alternatively, it can be given in terms of a parabolic form. If the duty can be given in such a way that the response speed will be slower than when returned only by the force of the return spring 11 in the final stage, the noise of collision between the gear 8 and the full opening stopper 13 and the impact load can be reduced.

As described above, in the present embodiment, when the EGR or DPF control is determined to have been terminated and the throttle valve is moved to the full opening position, the duty applied to the motor is reduced gradually. This arrangement reduces the speed at the time of collision between the gear and the full opening stopper and avoids generation of collision noise and reduction in the service life of the mechanical parts due to impact load.

Referring to FIGS. 37 and 38, the following describes the control operation of the control section 218 in the electronically controlled throttle device according to the second embodiment of the present invention.

The system configuration of the electronically controlled throttle device according to the present embodiment is the same as the one illustrated in FIG. 21. The configuration of the electronically controlled throttle device according to the present embodiment is the same as those shown in FIGS. 24 through 31. Further, the system configuration of the throttle actuator control unit (TACU) 200 of the electronically controlled throttle device according to the present embodiment is the same as that shown in FIG. 33. The configuration of the H bridge circuit 234 used in the electronically controlled throttle device according to the present embodiment is the same as that shown in FIG. 34.

FIG. 37 is a flow chart showing the specific control items of the control section of the electronically controlled throttle device in the second form of embodiment. FIG. 38 is an explanatory diagram showing the specific control items of the control section of the electronically controlled throttle device in the second form of embodiment. It should be noted that the same step numbers as those in FIG. 35 indicate the same control items.

In FIG. 38, the horizontal axis indicates the time t, while the vertical axis shows the throttle valve opening (control opening) θth. The throttle valve opening θth closer to the origin is closer to the full closing side of the throttle valve, while the throttle valve opening θth farther from the origin is closer to the full opening side.

In the Step S100, the control section 28 determines if the EGR control or DPF control have been terminated or not. If they have not been terminated, the control section 218 continues the normal feedback control. Upon termination, the control section 218 performs status control of the motor drive circuit in Step S210. Then in the next Step S220, stop control of the motor drive is performed. It should be noted that processing in the Steps S100 through S220 is repeatedly carried out in a cycle of 3 ms, for example.

In the processing of Step S210, the control section 218 outputs a control signal for causing regenerative braking of the motor 5 to the control amount computation section 216. As described with reference to FIG. 33, when ON signal is supplied to the gates G3 and G4 of the transistors TR3 and TR4, and when the motor 5 rotates, a current flows in the arrow-marked direction C3 and the motor 5 starts the regenerative braking operation. For performing such a manner, the control section 218 outputs the control signal for causing conduction of the transistors TR3 and TR4 to the control amount computation section 216. The control amount computation section 216 outputs the control signal for causing conduction of the transistors TR3 and TR4 to the logic IC 232. At the time, the throttle valve 2 moves in the full opening direction by the spring force of the return spring 11. The movement of the throttle shaft is transmitted to the motor 5 through the gears 8, 7 and 6. Thus the motor 5 performs regenerative braking operation. Regenerative braking operation of the motor 5 puts on a brake to the throttle valve movement where the throttle valve moves in the full opening direction.

To be more specific, what is a key point is that the motor circuit is connected to ground by controlling on/off state of some transistors of the H bridge circuit when the power supply for the motor is turned off. That is, when the power supply for the motor is turned off, the motor drive mechanism rotates in the full opening direction by the spring force of the return spring 11. During this return operation of the throttle valve, the motor circuit is connected to ground by controlling on/off state of some transistors of the H bridge circuit. Thus, the motor produces the force for making work the brake to the rotor of the DC motor 5 in the direction opposite to the spring force of the return spring. This control allows the throttle valve 2 to move slowly, just as when the motor drive circuit is connected, as shown in FIG. 38. This arrangement prevents an abrupt collision between the gear 8 and full opening stopper.

In the Step S220, the control section 218 outputs the control signal for stopping the motor drive to the control amount computation section 216. To be more specific, the control section 218 outputs the control signal for causing the motor applied duty Du to reach 0% to the control amount computation section 216. The control signal for causing the motor applied duty Du to reach 0% is then outputted to the logic IC 232 by the control amount computation section 216. This arrangement cuts off power supply to the motor, thereby the throttle valve 2 moves in the full opening direction by the return spring 11.

Further, the motor drive stop control may be provided by turning off the power supplied to the motor 5. Namely, the control section 218 turns off the switch SW1 illustrated in FIG. 33 to ensure that the power from the power supply VB is not supplied to the motor through the motor drive circuit 230. As described above, in the motor drive stop control, the power of the motor is turned off and the motor drive is stopped by setting the motor applied duty DU at 0%, and by turning off the transistor of the circuit of the H bridge circuit or the switch provided at some midpoint in the passage for supplying the power of the power source to the motor.

To be more specific, a brake is applied instantaneously to the movement in the full opening direction by processing in the Step S210. After then, the brake is released by the processing in the next Step S220, and the throttle valve moves in the full opening direction by the return spring 11. Processing in the Steps S100 through S220 is repeated at a cycle of 3 ms, for example. When the EGR or DPF control is determined to have been terminated, braking in the Step S210 and brake-free controlling the Step S220 are repeated during this time. The throttle valve gradually moves to the full opening side and reaches the full opening point at time t6, for example.

In the drawing, time duration T4 is the same as that shown in FIG. 36. It shows the throttle valve opening when the brake is not applied at all. By contrast, in the present embodiment, a brake is applied cyclically along the way, and the time duration T6 from time t3 through t6 gets longer than time duration T4. This arrangement reduces the speed at the time of collision between the gear 8 and the full opening stopper 13A when the throttle valve is pulled to the full opening point, and prevents reduction in the service life of the mechanical parts due to impact load. As described above, in the present embodiment, when EGR or DPF control is determined to have been terminated and the throttle valve is moved to the full opening position, the regenerative braking must be applied to the motor in the first place. To do so, a signal for ensuring the motor drive circuit in the control unit to be kept connected with the motor is given from the control section of the CPU. The force based on the rotating force of the motor acts as a brake in the direction opposite to the force of the spring exerted to rotate in the direction of the full opening position. This arrangement reduces reducing the energy at the time of collision of the components of the motor drive mechanism such as the full opening stopper and gear, and hence avoids generation of collision noise and reduction in the service life of the mechanical parts due to impact load.

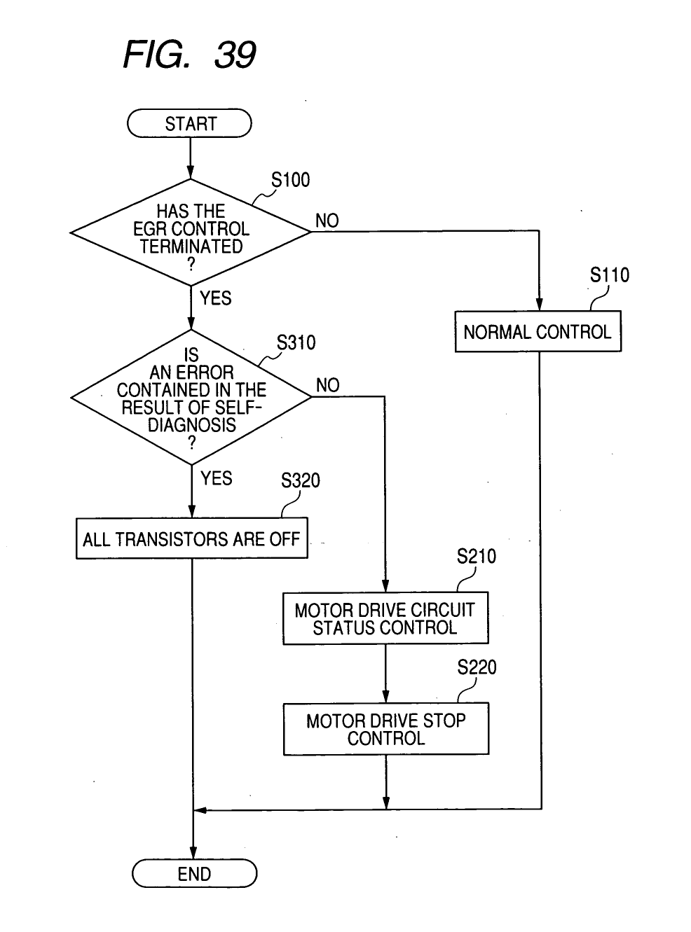

Referring to FIG. 39, the following describes the control operation by the control section 218 of the electronically controlled throttle device in the third embodiment.

The system configuration of the electronically controlled throttle device in the present embodiment is the same as the one given in FIG. 21. The configuration of the electronically controlled throttle device in the present embodiment is also the same as the ones given in FIGS. 24 through 31. The system configuration of the throttle actuator control unit (TACU) 200 of the electronically controlled throttle device in the present embodiment is also the same as the one given in FIG. 33. The configuration of the H bridge circuit 234 of the electronically controlled throttle device in the present embodiment is also the same as the one given in FIG. 34.

FIG. 39 is a flow chart showing the specific control items of the control section of the electronically controlled throttle device in the third embodiment. The same step numbers as those in FIGS. 35 and 37 denote the same control items.

In the present embodiment, the processing of Steps S310 and S320 is added to that of FIG. 37.

In the Step S100, when the EGR or DPF control is determined to have been terminated, the self-diagnosis flag is checked in the Step S310. If any error has been detected, the regenerative braking and motor drive stop in the Steps S210 and S220 causes the behavior when the motor circuit is connected. Then the throttle valve slowly received with the full opening stopper 13.

If any error has been detected in the self-diagnosis, the control section 218 turns off all the transistors of the H bridge circuit in the Step S320. As shown by the one-dot chain line of FIG. 36, the throttle valve moves quickly to the full opening position.

As described above, if any error has been detected in the self-diagnosis, the control is stopped as quickly as possible. This prevents a failure in the behavior of an actual vehicle.

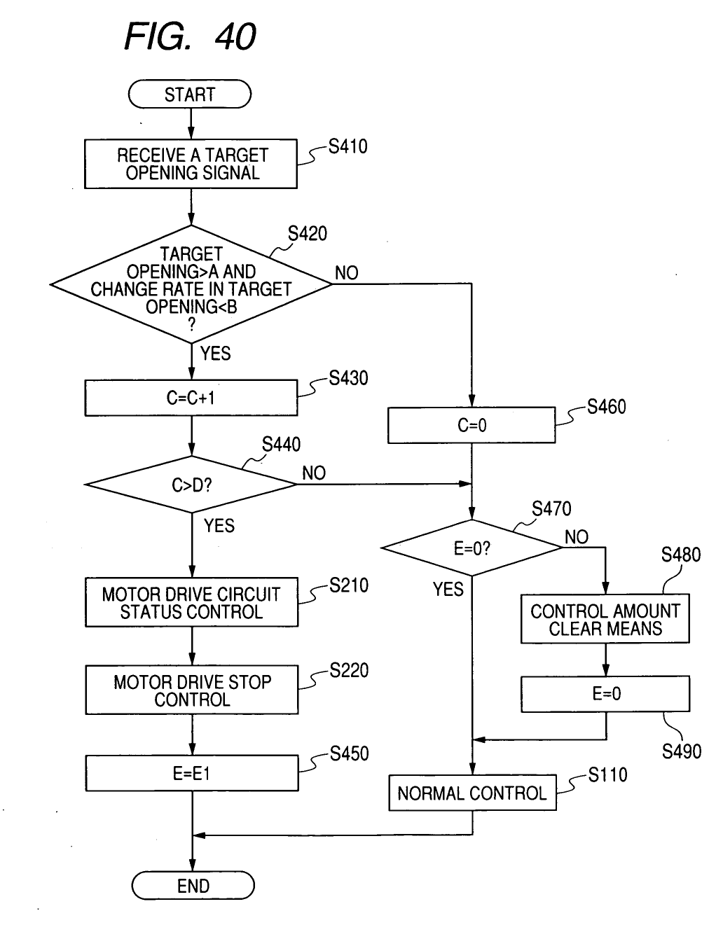

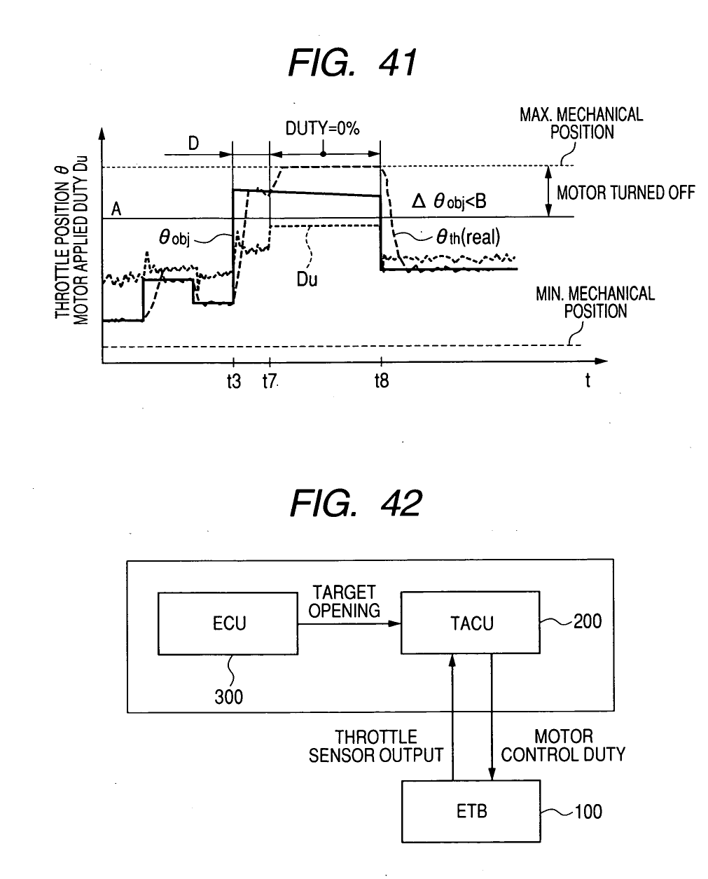

Referring to FIGS. 40 and 41, the following describes the control operation performed by the control section 218 of the electronically controlled throttle device as a fourth embodiment of the present invention.

The system configuration of the electronically controlled throttle device in the present embodiment is the same as the one given in FIG. 21. The configuration of the electronically controlled throttle device in the present embodiment is also the same as the ones given in FIGS. 24 through 31. The system configuration of the throttle actuator control unit (TACU) 200 of the electronically controlled throttle device in the present embodiment is also the same as the one given in FIG. 33. The configuration of the H bridge circuit 234 of the electronically controlled throttle device in the present embodiment is also the same as the one given in FIG. 34.

FIG. 40 is a flow chart showing the specific control items of the control section of the electronically controlled throttle device as a fourth form of embodiment. FIG. 41 is an explanatory diagram showing the specific control items of the control section of the electronically controlled throttle device as the fourth embodiment. The same step numbers as those in FIGS. 35 and 37 denote the same control items.

In FIG. 41, the horizontal axis represents time t. The vertical axis indicates the throttle position θth and motor duty Du. The throttle position θ closer to the full closing position is located closer to the origin, while the position closer to the full opening position is farther from the origin. The solid line indicates the target opening θobj, and the broken line denotes the real opening θth (real). The motor duty Du is indicated by the dotted line. The motor duty Du closer to 100% is located closer to the origin, while the motor duty Du closer to 0% is located farther from the origin.

In the step S410, the control section 218 is received the target opening θobj which becomes a target for throttle valve positioning control.

In the Step S420, a decision is made on whether or not the target opening θobj is greater than a predetermined value A and the change rate Δθobj of the target opening θobj is smaller than a predetermined value B. For example, the predetermined value A is 80%, and based on the predetermined A, a decision is made on the EGR or DPF control in the Step S100 of FIG. 24 has terminated. The change rate Δθobj of the target opening θobj is used as a reference for determining whether or not the target opening θobj is greater than the predetermined value A on a steady-state, except when the target opening θobj has become greater than the predetermined value A instantaneously. The change rate Δθobj is 0.25%, for example. To be more specific, when the target opening θobj is greater than the predetermined value A (e.g. 80%) and the change rate Δθobj of the target opening θ obj is smaller than the predetermined value B (e.g. 0.25%), a decision is made to determine that the EGR or DPF control has been terminated. The system then goes to the Step S430. If not, the system goes to the Step S460.

In the Step S460, the count is 0-cleared for initialization. In other words, the count A is zero under the normal EGR or DPF control. In the Step S470, a decision is made to see if a variable E is 0 or not. The variable E is a binary value taking either 0 or 1. If it takes 0, control is performed. If it is 1, control is not performed. In this example case, assuming that the control is performed and the variable E is set to 0, the system goes to the Step S110, and feedback control is carried out so that the throttle valve opening reaches the target opening. In FIG. 41, the opening of the throttle valve is controlled by the normal feedback control before time t3 is reached. At this time point, since the EGR or DPF control has already terminated, the target angle control of throttle valve in this case is set at a predetermined opening point close to the full opening. In this case, the throttle valve is controlled so as to reach such predetermined opening point and the opening point is maintained for a predetermined period of time (time before the requirement of C>D is satisfied in Step S440).

When the EGR or DPF control is terminated, “1” is added to the count C in the Step S430. In the Step S440, a decision is made to see if the count C has exceeded the predetermined value D or not. The decision in the Step S440 is intended to see whether or not a predetermined time has elapsed after the EGR or DPF control is determined to be terminated. The predetermined value D is assumed as representing the value corresponding to the time duration from time t3 through time t7 in FIG. 41. For example, it corresponds to the time for counting 200 ms. This predetermined time duration is set longer than the time duration (time duration T4 in FIG. 36 (e.g. 150 ms)) required for movement to the full opening side by the spring force of the return spring, shown by the one-dot chain line of FIG. 36.

If the requirement of Step S440 is not met, namely, until 200 ms has elapsed after termination of the EGR or DPF control, a decision is made in the Step S470 to see whether or not the variable E is “1”, for example. In this case, control is carrying out, the variable E is 0, and control mode goes to the Step S110, and feedback control is performed to ensure that the throttle valve opening will reach the target opening. To be more specific, the throttle valve opening control is provided by normal feedback control even during the time period from t3 through t6, as shown in FIG. 41.

The aforementioned control reduces the wear of the sliding resistor of the throttle sensor. In the case of the electronically controlled throttle device using a contact type throttle sensor, if the predetermined time maintaining time (e.g. time duration for holding at the full opening position) is longer, the local wear of the resistor may be caused by vibration and other factors. Such a local wear may produce an output error of the contact type throttle position sensor. To avoid this in the present embodiment, control state is maintained before the lapse of the time corresponding to the predetermined value D, even when the EGR or DPF control has terminated. This arrangement ensures a given opening to be maintained for the time period from t3 through t7. The time period when the mechanical full opening position is maintained lasts from t7 through t8, thereby cutting down the time period when the mechanical full opening position. As described above, the holding time can be reduced, and this arrangement ensures a longer service life of the throttle position sensor.

If the count C has exceeded the predetermined value D according to the decision made in the Step S440, namely, if the time t7 has reached in FIG. 41, then the braking operation by regenerative braking and non-braking operation described with reference to FIG. 37 are repeated in the Steps S210 and S220. The gear 9 comes into contact with the full opening stopper 13 gradually. It should be noted that, of the processing of the Steps S210 and S220, the processing of the Step S210 can be omitted. Because, in the Step S110, the throttle valve is controlled at a predetermined position close to the full opening point for a predetermined time period. Accordingly, even if the power supply to the motor is turned off by the processing of the Step S220 and this operation is immediately followed by the movement to the full opening position from the predetermined position, the impact of the gear against the full opening stopper 13A at the time of collision with each other is small in many cases since the traveling distance is short.

After that, the control status flag (E) is set to “1” in the Step S450, and the control exits the loop.

As described above, in the present embodiment, after time t7 when the EGR range (after time t3) is reached and the continuation time for condition holding state (C>D) has been satisfied, braking and stop of power supply to the motor are repeated. The control state is shifted to the non-control state, and the gear 8 and full opening stopper 13 are gradually brought into contact with each other.

Further, the EGR or DPF control can be returned from the state where the EGR or DPF control is terminated if any one of the conditions—target opening>A, change rate in target opening<B, and C>D—is not met. In this case, since the non-control state has occurred once, the control state Flag is E=1. According to the decision made in the Step S470, the process goes to the Step S480 and the control amount is cleared.

As described with reference to FIG. 33, PID computation for obtaining the duty is repeatedly carried out, independently of whether EGR or DPF control is applied, or the EGR control is not applied. Thus, the PID control amount u(t)=(Kp*Δθth+Kd*(dΔθth/dt)+Ki*ΣΔθth*dt) is computed. When the supply of power to the motor is cut off, the deviation between the target opening and actual opening is increased in the direction of closing. For the portion serving as the integration item, the duty in the direction of closing is excessive. In the throttle position control, a brake is normally applied close to the new target opening to enhance the convergence. If the values corresponding to the integration items are accumulated excessively in the direction of closing, as described above, the normal brake is not applied and the overshoot is increased, with the result that convergence is deteriorated in some cases.

To solve this problem in the present embodiment, the control amount is zero-cleared in the Step S480. In this case, the control amount for zero clearing can be the portion corresponding to the integration item alone, or all the values involved in the applied duty. This will enhance the control performance such as response time. After that, the control state flag is set to E=0 in the Step S490, and a normal control is regained to exit the loop.

As described above, the present embodiment reduces the impact energy at the time of collision between the components of the motor drive mechanism such as the full opening stopper and gear, and avoids reduction in the service life of the mechanical parts due to impact load. It also reduces the holding time at the full opening position and ensures an longer service life of the contact type throttle sensor. Further, when the control is to be applied from the state where control is not applied, the control amount is zero-cleared. This enhances the control performances such as response.

Referring to FIG. 42, the following describes the system configuration of the electronically controlled throttle device according to another embodiment of the present invention.

FIG. 42 is a system configuration diagram of the electronically controlled throttle device as another embodiment.

In the aforementioned description of the embodiment, the TACU 200 and ECU 300 have independent structures. However, they can be integrally built as one structure, as shown in FIG. 42.

The following summarizes the features of the throttle valve apparatus as an intake throttle valve based on the motor control in the aforementioned present embodiment, and the control method thereof.

In the electronically controlled throttle device of the throttle valve, as described in the Official Gazette of Japanese Application Patent Laid-open Publication No. Hei 7-332136, the control amount in response to the difference between the throttle valve opening and the target opening is computed by the PID control method and other technique, and the control amount having been obtained is converted into the duty ratio as a ratio of the on time and off time of the pulse drive. The PWM signal is supplied to the DC motor through the H bridge circuit and the motor generates the torque. The throttle valve is driven by the generated torque through the gear and throttle shaft, whereby the position control is provided. Such an electronically controlled throttle device has been known in the prior art.

The aforementioned electronically controlled throttle device is an electronically controlled throttle device for gasoline engine. For the sake of EGR efficiency improvement and dieseling improvement, the electronically controlled throttle device is going to be applied to the diesel engine. The electronically controlled throttle device for diesel engine, unlike the one for gasoline engine, increases the exhaust gas temperature mainly by improving the EGR efficiency and reducing the amount of air intake, and is controlled to burn out deposition in the DPF (diesel particulate filter). When the EGR or DPF control is not carried out, the motor control is suspended and the throttle valve is located at the full opening position. Thus, big differences are: 1) being held at the full opening position for long time; 2) presence of the state in which the on-going motor control has been terminated or the state in which motor control has been restarted; and 3) elimination of the need of providing a default mechanism wherein a predetermined amount of air is supplied at a predetermined opening when the motor has been turned off, due to the absence of out-of-control mode.

In the electronically controlled throttle device for diesel engine, there is no further need of controlling the air flow rate if EGR or DPF control has terminated. The motor is then turned off and the throttle valve is returned to the full opening position with the minimum pressure loss by the return spring. To be more specific, unlike the case of an electronically controlled throttle device for the gasoline engine normally placed under control, there is a state in which the on-going motor control has been terminated or a state in which motor control has been restarted.

In the first place, consider a state in which the on-going motor control has been terminated. The first problem is as follows. Assume that the motor is merely turned off or the applied duty is set to 0% when control has been suspended. Also assume that the throttle valve is moved to the full opening position only by the force of the return spring exerted in the direction of opening. This arrangement will raise the problem: wherein the full opening stopper and drive mechanism component collide with each other; thereby a impact noise is occurred; and the service life of the mechanical components due to impact load is reduced.

To solve this problem, for example, in an electronically controlled throttle device described in the Japanese Application Patent Laid-open Publication No. 2002-256892, a shock absorber (buffer mechanism) is provided between the full opening stopper and the gear, thereby solving the problem of collision of mechanical parts.

Another example is disclosed in the electronically controlled throttle device described in the Japanese Application Patent Laid-open Publication No. 2003-214196, wherein the predetermined electric value set in advance is applied to the motor for a predetermined period of time, and the motor is operated at a speed lower than under normal control, thereby solving the problem of collision through the control technique.

However, the method disclosed in the Japanese Application Patent Laid-open Publication No. 2002-256892, is accompanied by the problems of: increased cost for the installation of a buffer mechanism; reduced advantages in the event of possible deterioration of the buffer mechanism; and reduced level of reliability resulting from increased number of parts.

Further, the technique disclosed in the Japanese Application Patent Laid-open Publication No. 2003-214196 uses the control method, wherein the predetermined value set in advance is applied to the motor for a given period of time. This method fails to absorb the variations in the response time among individual products, and the motor driving control may not be discontinued even when the throttle valve has returned to the full opening position. This will raise the problem of causing a damage to the motor due to overcurrent, and a damage to the mechanical parts exposed to the resulting overloads.

The aforementioned problems are solved by the present embodiment which provides an electronically controlled throttle device characterized by improved reliability free from any damage to the motor or mechanical parts, wherein the impact noise or impact energy of mechanical parts is minimized.

To achieve the aforementioned object, the present embodiment provides:

(1) An electronically controlled throttle device comprising:

an actuator for driving the throttle valve incorporated rotatably in a throttle body;

a return spring for applying an spring force to return the throttle valve in the direction of full opening; and

a throttle position sensor for sensing the opening of the throttle valve;

an electronically controlled throttle body including aforementioned actuator, return spring and throttle position sensor;

a throttle actuator control unit for driving the actuator in response to the opening of the throttle valve detected by the throttle position sensor, and the target opening;

wherein the throttle actuator control unit is provided with a control means to control the actuator in such a way that, at the time of termination of the EGR or DPF control, the throttle valve is moved in the direction of full opening in the time longer than when the throttle valve is moved in the direction of full opening by the return spring only.

This structure improves reliability without any damage to the motor or mechanical parts and reduces the impact noise and impact energy of mechanical parts.

(2) In the electronically controlled throttle device with the aforementioned Structure (1), the control means preferably is set so as to execute open-loop control where the control means provides the actuator with the control signal as a target angle for moving the throttle valve gradually in the direction of full opening.

(3) The electronically controlled throttle device mentioned in the aforementioned Structure (2), wherein the aforementioned control means preferably reduces gradually the duty signal supplied to the actuator.

(4) The electronically controlled throttle device mentioned in the aforementioned Structure (1), wherein, at the time of termination of the EGR or DPF control, the control means preferably repeats the control state and non-control state for the actuator.

(5) The electronically controlled throttle device mentioned in the aforementioned Structure (4), wherein the control means preferably provides control in such a way that the actuator works as a brake in the aforementioned control state.

(6) The electronically controlled throttle device mentioned in the aforementioned Structure (4), wherein the control means preferably controls the actuator with the regenerative brake applied, in the aforementioned control state.

(7) The electronically controlled throttle device mentioned in the aforementioned Structure (4), wherein the control means preferably cuts off the power supplied to the actuator, in the aforementioned non-control state.

(8) The electronically controlled throttle device mentioned in the aforementioned Structure (7), wherein the control means preferably supplies the actuator with a 0% duty signal.

(9) The electronically controlled throttle device mentioned in the aforementioned Structure (4), wherein the aforementioned control means preferably cuts off the power supplied to the actuator, if the result of self-diagnosis made by a throttle position sensor and others is abnormal.

(10) The electronically controlled throttle device mentioned in the aforementioned Structure (4), wherein the control means preferably controls so that the opening of the throttle valve is kept close to the full opening point for a predetermined time during a predetermined period for time after the EGR or DPF control is determined to have terminated; and then the aforementioned control state and non-control state of the actuator are repeated.

(11) The electronically controlled throttle device mentioned in the aforementioned Structure (1), wherein the control means preferably controls so that the opening of the throttle valve is kept close to the full opening point for a predetermined time during a predetermined period for time after the EGR or DPF control is determined to have terminated; and the actuator is placed out of non-control state.

(12) The electronically controlled throttle device mentioned in the aforementioned Structure (11), wherein the control means preferably controls so that the opening of the throttle valve is kept close to the full opening point for a predetermined time during a predetermined period for time after the EGR or DPF control is determined to have terminated; and the aforementioned control state and non-control state of the actuator are repeated.

(13) The electronically controlled throttle device mentioned in the aforementioned Structure (11), wherein the control means is preferably arranged in such a way that the EGR or DPF control is determined to have terminated:

if the target opening of the aforementioned throttle valve exceeds the predetermined target opening and the change rate of the target opening does not exceed the change rate of the predetermined opening; and

if the target opening is equal to or greater than the predetermined opening and the change rate thereof does not exceed the change rate of the predetermined opening for more than predetermined period of time.

(14) The electronically controlled throttle device mentioned in the aforementioned Structure (12), wherein the control means is preferably arranged in such a way that, after the EGR or DPF control is determined to have terminated, the actuator control is restarted if at least one of the aforementioned three requirements is not met.

(15) The electronically controlled throttle device mentioned in the aforementioned Structure (13), wherein the control means is preferably arranged in such a way that the aforementioned actuator control is restarted after the value of the actuator drive duty computation section is initialized.

(16) The electronically controlled throttle device mentioned in the aforementioned Structure (15), wherein the control means is arranged in such a way that the aforementioned initialization of the value of the actuator drive duty computation section is realized by initialization of the integration item or the portion providing corresponding services.

(17) The electronically controlled throttle device mentioned in the aforementioned Structure (1), wherein the electronically controlled throttle body comprises:

a first gear fixed to the output shaft of the actuator;

a second gear fixed to the throttle shaft supporting the throttle valve; and

an intermediate gear for transmitting a drive force to the second gear from the first gear;

wherein a washer as a wear-resistant member is interposed between the intermediate gear and the throttle body supporting the intermediate gear.

(18) To achieve the aforementioned object, the present embodiment further is arranged as follows.

An electronically controlled throttle device comprising:

an actuator for driving the throttle valve incorporated rotatably in a throttle body;

a return spring for applying an spring force to return the throttle valve in the direction of full opening; and

a throttle position sensor for sensing the opening of the throttle valve;

an electronically controlled throttle body including aforementioned actuator, return spring and throttle position sensor;

a throttle actuator control unit for driving the actuator in response to the opening of the throttle valve detected by the throttle position sensor, and the target opening;

wherein the throttle actuator control unit is provided with a control means control means which executes open-loop control for providing the actuator with the control signal as a target angle for moving the throttle valve gradually in the direction of full opening, in order to control the actuator in such a way that, at the time of termination of the EGR or DPF control, the throttle valve is moved in the direction of full opening in the time longer than when the throttle valve is moved in the direction of full opening by the return spring only.

This structure improves reliability without any damage to the motor or mechanical parts and reduces the impact noise and impact energy of mechanical parts.

(19) To achieve the aforementioned object, the present embodiment further is arranged as follows.

An electronically controlled throttle device comprising:

an actuator for driving the throttle valve incorporated rotatably in a throttle body;

a return spring for applying an spring force to return the throttle valve in the direction of full opening; and

a throttle position sensor for sensing the opening of the throttle valve;

an electronically controlled throttle body including aforementioned actuator, return spring and throttle position sensor;

a throttle actuator control unit for driving the actuator in response to the opening of the throttle valve detected by the throttle position sensor, and the target opening;

wherein the throttle actuator control unit is provided with a control means which repeats the control state and non-control state for the actuator so that, at the time of termination of the EGR or DPF control, the throttle valve is moved in the direction of full opening in the time longer than when the throttle valve is moved in the direction of full opening by the return spring only; and

wherein, the control means in order to carry out the aforementioned operation at the time of termination of the EGR or DPF control.

This structure improves reliability without any damage to the motor or mechanical parts and reduces the impact noise and impact energy of mechanical parts.

(20) To achieve the aforementioned object, the present embodiment further is arranged as follows.

An electronically controlled throttle device comprising:

an actuator for driving the throttle valve incorporated rotatably in a throttle body;

a return spring for applying an spring force to return the throttle valve in the direction of full opening; and

a throttle position sensor for sensing the opening of the throttle valve;

an electronically controlled throttle body including aforementioned actuator, return spring and throttle position sensor;

a throttle actuator control unit for driving the actuator in response to the opening of the throttle valve detected by the throttle position sensor, and the target opening;

wherein the throttle actuator control unit is provided with a control means which controls so that the opening of the throttle valve is kept close to the full opening point for a predetermined time during a predetermined period for time after the EGR or DPF control is determined to have terminated; and the aforementioned control state and non-control state of the actuator are repeated, in order to control the actuator in such a way that, at the time of termination of the EGR or DPF control, the throttle valve is moved in the direction of full opening in the time longer than when the throttle valve is moved in the direction of full opening by the return spring only.

This structure improves reliability without any damage to the motor or mechanical parts and reduces the impact noise and impact energy of mechanical parts.

(21) To achieve the aforementioned object, the present embodiment further is arranged as follows.

An electronically controlled throttle device comprising:

an actuator for driving the throttle valve incorporated rotatably in a throttle body;

a return spring for applying an spring force to return the throttle valve in the direction of full opening; and

a throttle position sensor for sensing the opening of the throttle valve;

an electronically controlled throttle body including aforementioned actuator, return spring and throttle position sensor;

a throttle actuator control unit for driving the actuator in response to the opening of the throttle valve detected by the throttle position sensor, and the target opening;

wherein the throttle actuator control unit is provided with a control means which controls so that the opening of the throttle valve is kept close to the full opening point for a predetermined time during a predetermined period for time after the EGR or DPF control is determined to have terminated; and the actuator is placed out of non-control state, in order to control the actuator in such a way that, at the time of termination of the EGR or DPF control, the throttle valve is moved in the direction of full opening in the time longer than when the throttle valve is moved in the direction of full opening by the return spring only.

This structure improves reliability without any damage to the motor or mechanical parts and reduces the impact noise and impact energy of mechanical parts.

(22) To achieve the aforementioned object, the present embodiment further is arranged as follows.

An electronically controlled throttle device comprising:

an actuator for driving the throttle valve incorporated rotatably in a throttle body;

a return spring for applying an spring force to return the throttle valve in the direction of full opening; and

a throttle position sensor for sensing the opening of the throttle valve;

an electronically controlled throttle body including aforementioned actuator, return spring and throttle position sensor;

a throttle actuator control unit for driving the actuator in response to the opening of the throttle valve detected by the throttle position sensor, and the target opening;

wherein the electronically controlled throttle body comprises:

a first gear fixed to the output shaft of the actuator;

a second gear fixed to the throttle shaft supporting the throttle valve; and

an intermediate gear for transmitting a drive force to the second gear from the first gear;

wherein a washer as a wear-resistant member is provided between the intermediate gear and the throttle body supporting the intermediate gear.

The following describes the details of the EGR gas control system as an embodiment to which the present invention is applied.

FIG. 10 is schematic diagram representing the structure of the exhaust gas recirculation system of an internal combustion engine as an embodiment to which the present invention is applied.

An air cleaner 41 removes dust from the air having been taken into the engine. The intake air rate G1 is sensed by an air flow sensor 42. The signal of the intake air rate G1 having been sensed is inputted into the engine control unit (ECU) 421 and exhaust gas recirculation controller (EGR CONT) 420. Intake air is pressurized by the compressor 43 of the turbo charger, after that, is passed through the intake pipe 44, and the flow rate or pressure thereof is controlled by the intake flow rate control valve 5. The intake air is further fed into the intake manifold 6 and is distributed to the cylinders of the engine 47.

The opening of the air intake control valve 45 is controlled by the intake flow rate control signal C TH outputted from the exhaust gas recirculation controller 420. The air intake control device 45 is comprised of a butterfly valve to tube driven by a motor, for example. The opening of the butterfly valve is sensed and the result is taken in by the exhaust gas recirculation controller 420 as the opening signal θTH.

The fuel injection valve 419 provided on the engine 47 supplies the cylinder of the engine 47 with the combustion fuel. The fuel is supplied to the fuel injection valve 419 by the fuel pipe 418 through the fuel pump 417. The injection rate of the fuel injection valve 419 is controlled by the ECU 421. The ECU 421 supplies the fuel injection valve 419 with the fuel injection rate signal FINI.

The exhaust gas subsequent to combustion in the engine is collected by the exhaust gas manifold 48, after that, passes through the turbine 49 of the turbocharger. The exhaust gas goes through the catalyst 410 and exhaust pipe to be discharged into the atmosphere. The exhaust gas manifold 48 is provided with a branch 412. Part of the exhaust gas from the engine 47 is distributed. The exhaust gas having been distributed is led to the recirculation pipe 413a as a recirculating gas. The recirculation pipe 413a is provided with a recirculation gas cooler 414. The recirculation gas having been cooled by the recirculation gas cooler 414 passes through the recirculation pipe 413b and recirculation gas control valve 416, and is recirculated to the air intake passage 46.

The opening of the recirculation gas control valve 416 is controlled by the opening control signal CEG of the recirculation gas control valve 416 outputted from the exhaust gas recirculation controller 420. The recirculation gas control valve 416 is a seat valve type, for example. The stroke of the seat valve is sensed and is taken in by the exhaust gas recirculation controller 420 as a stroke signal ST EG. When a butterfly valve is used as the recirculation gas control valve 416, for example, the opening signal of the butterfly valve is taken in by the exhaust gas recirculation controller 420.

The recirculation pipe 413b is provided with a recirculation gas flow rate sensor 415, which measures the flow rate G2 of the recirculation gas flowing through the recirculation pipe. The flow rate G2 of the recirculation gas having been measured is inputted into the exhaust gas recirculation controller 420. It should be noted that the recirculation gas cooler 414 is provided to reduce the temperature of the recirculation gas, but can be omitted.

The rotational speed signal NE of the engine 7 and intake air rate signal G1 from the air flow sensor 2 as well as the signal for the state of engine and vehicle (not illustrated) are inputted into the ECU 421. Based on these signals, the ECU 21 performs computation and sends the result of computation as the control instruction value to various devices. Based on such signals the rotational speed signal NE of the engine 7 and intake air rate signal G1, the ECU 421 evaluates the engine operation conditions. In response to the engine operation conditions, the ECU 421 outputs the recirculation gas recirculation rate instruction value R SET to the exhaust gas recirculation controller 420.

The exhaust gas recirculation controller 420 computes the recirculation rate R of exhaust gas from the intake air rate signal G1 and recirculation gas flow rate G2. The exhaust gas recirculation controller 420 executes feedback control of the opening of the air intake air control valve 45 and/or recirculation gas control valve 416A to ensure that the recirculation rate R having been obtained matches the recirculation gas recirculation rate instruction value R SET. To be more specific, the present embodiment is characterized in that not only the recirculation gas control valve 416 but also the air intake control valve 45 are controlled to ensure that the amount of the recirculated exhaust gas will meet the target value.

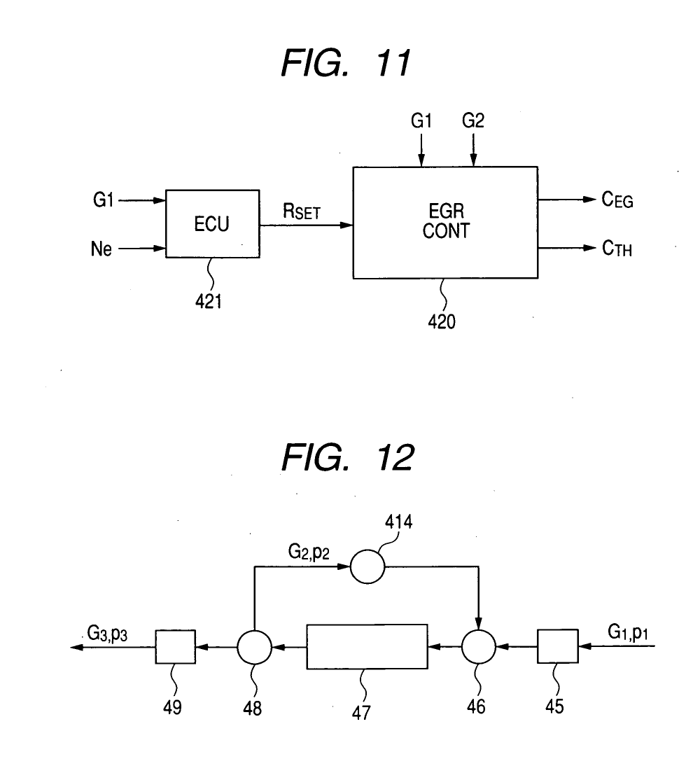

Referring to FIGS. 11 and 12, the following describes the specific control items of the exhaust gas recirculation controller in the exhaust gas recirculation device according to the present embodiment.

FIG. 11 is a block diagram representing the control system of the exhaust gas recirculation device of the internal combustion engine to which the present invention is applied. FIG. 12 is a flow chart showing the specific control items of the exhaust gas recirculation controller in the exhaust gas recirculation device of the internal combustion engine to which the present invention is applied. It should be noted that the same reference numerals as those of FIG. 10 indicate identical components.

As shown in FIG. 11, the recirculation gas recirculation rate instruction value R SET outputted from the ECU 421, the intake air rate signal G1 sensed by the air flow sensor 42 and the recirculation gas flow rate G2 sensed by the recirculation gas flow rate sensor 415 are inputted into the exhaust gas recirculation controller 420. To ensure that the recirculation rate R of exhaust gas will meet the target value R SET, the exhaust gas recirculation controller 420 outputs the opening control signal C EG to the recirculation gas control valve 416, and outputs the air intake flow rate control signal C TH to the intake flow rate control valve 5, thereby controlling these valves 416 and 45. The exhaust gas recirculation controller 420 computes the recirculation rate R of exhaust gas as (G2/(G1+G2)) based on the intake air rate signal G1 and recirculation gas flow rate G2.

It is assumed in the following description that the response of the air intake control valve 45 is faster than that of the recirculation gas control valve 416. To put it more specifically, assume that a butterfly valve having a bore diameter of 50 mm is used, for example, and the exhaust gas recirculation control valve 416 is a seat valve having a seat diameter of 30 mm. In this case, the response of the air intake control valve 45 is assumed as faster than that of the recirculation gas control valve 416.

The following describes the specific control items of the exhaust gas recirculation controller with reference to FIG. 12. It should be noted that the control items are implemented by the exhaust gas recirculation controller 420.

In the Step S500 of FIG. 12, the exhaust gas recirculation controller 420 computes the recirculation rate R of exhaust gas as (G2/(G1+G2)) based on the intake air rate signal G1 and recirculation gas flow rate G2.

In the Step S510, a decision is made to determine whether or not the change rate ΔR SET of the target value R SET of the recirculation rate R of exhaust gas inputted from the ECU 421 is greater than the reference value ΔR0 set in advance. If the change ΔR SET is greater than the reference value ΔR0, the process goes to the Step S520. If not, the process goes to the Step S550. In other words, in the Step S510, a decision step is taken to determine whether or not the target value R SET of the recirculation rate R of exhaust gas has made a substantial change. A decision step is taken to determine whether or not there is a need for an abrupt change in the exhaust gas recirculation rate in order to reduce the deleterious substance in the exhaust gas due to transient change in the operation conditions of the internal combustion engine.

If the change ΔR SET is greater than the reference value ΔR0, namely, if there is a need for an abrupt change in the exhaust gas recirculation rate, a decision is made in the Step S520 to see whether or not the recirculation rate R of exhaust gas calculated in the Step S510 is equal to the target value R SET of the recirculation rate R of exhaust gas.

If the recirculation rate R is greater than the target value R SET, control is provided in the Step S530 so that the opening control signal C TH outputted to the air intake control valve 45 is reduced, and the opening of the intake flow rate control valve 5 is also reduced. Then the process goes back to the Step S520. This procedure is repeated until the recirculation rate R is equal to the target value R SET.

In the meantime, when the recirculation rate R is smaller than the target value R SET, control is provided in the Step S540 so that the opening control signal C TH outputted to the air intake control valve 45 is increased, and the opening of the air intake control valve 45 is increased. Then the process goes back to the Step S520. This procedure is repeated until the recirculation rate R is equal to the target value R SET.

As described above, procedures of Steps S520, S530 and S540 are repeated, whereby feedback control is carried out until the recirculation rate R is equal to the target value R SET. In this case, the response of the intake flow rate control valve 5 is faster than that of the recirculation gas control valve 416. This arrangement ensures an immediate change of the exhaust gas recirculation rate to a predetermined target value, even if there is a need for an abrupt change in the exhaust gas recirculation rate.

In the meantime, if it has been determined in the Step S510 that the change ΔR SET is smaller than the reference value ΔR0, namely, there is not much change in the exhaust gas recirculation rate, then a decision step is taken in the Step S550 to determine whether or not the recirculation rate R of exhaust gas calculated in the Step S510 is equal to the target value R SET of the recirculation rate R of exhaust gas.

If the recirculation rate R is greater than the target value R SET, control is provided in the Step S560 to ensure that the opening control signal C EG outputted to the recirculation gas control valve 416 is reduced and the opening of the recirculation gas control valve 416 is reduced. The system then goes back to the Step S550. This procedure is repeated until the recirculation rate R is equal to the target value R SET.

In the meantime, when the recirculation rate R is smaller than the target value R SET, control is provided in the Step S570 to ensure that the opening control signal C EG outputted to the recirculation gas control valve 416 is increased and the opening of the exhaust gas recirculation control valve 416 is increased. The process then goes back to the Step S570. This procedure is repeated until the recirculation rate R is equal to the target value R SET.

As described above, by the repetition of the procedures shown in Steps S550, S560 and S570, the feedback control is provided until the recirculation rate R is equal to the target value R SET. In this case, the response of the exhaust gas recirculation control valve 416 is faster than that of the air intake control valve 45. This means that finer opening control is enabled. This ensures a precise change of the exhaust gas recirculation rate to a predetermined target value.

In the above description, the response of the air intake control valve 45 is faster than that of the exhaust gas recirculation control valve 416. Conversely, the response of the exhaust gas recirculation control valve 416 may be faster than that of the air intake control valve 45 in some cases. To put it more specifically, assume that the air intake control valve 45 is a butterfly valve having a bore diameter of 30 mm, and the exhaust gas recirculation control valve 416 is a seat valve having a seat diameter of 50 mm. Then the response of the recirculation gas control valve 416 can be faster than that of the air intake control valve 45. In this case, when there is a need for an abrupt change of the exhaust gas recirculation rate, the recirculation gas control valve 416 of faster response is controlled. When there is no need of an abrupt change, the air intake control valve 45 of slower response is controlled, whereby control precision is enhanced.

In the aforementioned manner, when there is a need for an abrupt change of the exhaust gas recirculation rate, the control valve of faster response is controlled, thereby meeting the abrupt change. When there is no need of an abrupt change, the control valve of slower response is controlled, whereby control precision is enhanced.

If there is a need for an abrupt change of the exhaust gas recirculation rate as described above, the relationship between the response of the air intake control valve 45 and that of the recirculation gas control valve 416 is the same, independently of whether or not the recirculation gas control valve 416 is a butterfly valve as in the case of the previously described embodiment, or it is installed on the air intake passage as in the case of the previously described embodiment.

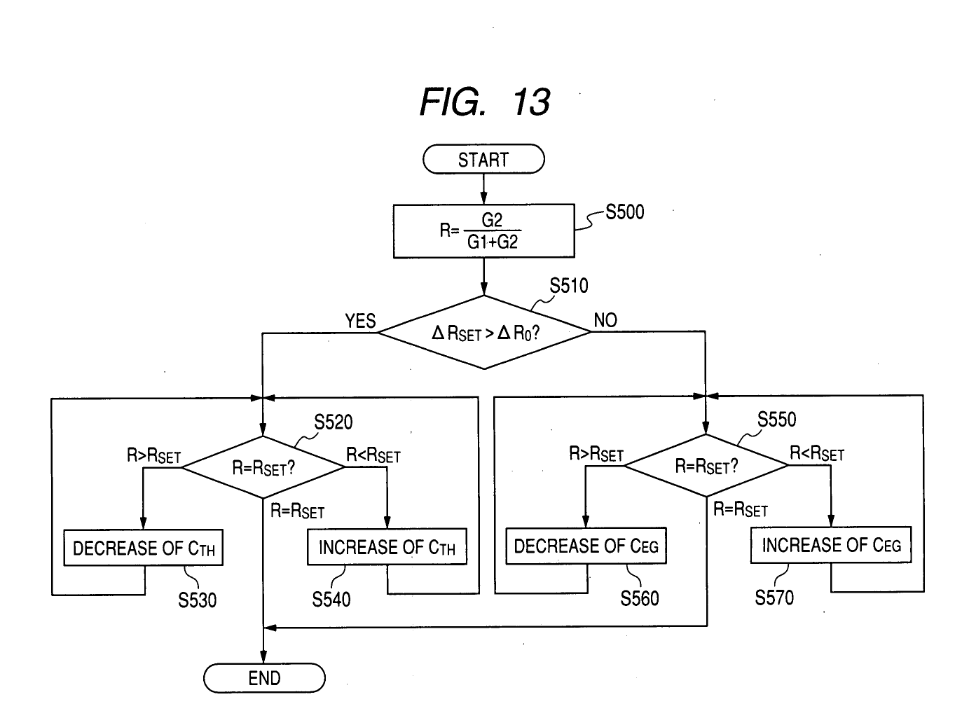

Referring to FIG. 13 the following describes the feedback control method of the exhaust gas recirculation controller in the exhaust gas recirculation device of an internal combustion engine according to the present invention:

FIG. 13 is a diagram showing a modeled representation of the portion ranging from the air intake control valve 45 of the engine 7 to the turbine 49 of the turbo charger on the exhaust gas side, in the exhaust gas recirculation device of an internal combustion engine as an embodiment of the present invention. It should be noted that the same reference numerals as those of FIG. 10 indicate the same components.

In FIG. 13, the flow rate and pressure of the air passing through the intake flow rate control valve 5 are represented as G1 and p1, respectively. The flow rate and pressure of the air passing through the turbine 9 of the turbocharger are represented as G3 and p3, respectively. The flow rate and pressure of the air passing through the recirculation pipe 413a on the exhaust gas side of the engine 47 are represented as G2 and p2, respectively, using the engine 7 as a reference in the recirculation gas control valve 416. The relationship in this system is expressed by the simultaneous equation of the following formulas (1), (2) and (3).
G1+G2=G3=f3(ne,ηv,p2) (1)
G1=f1(p1,p2,ξ) (2)
G2=f2(p2,p3,ξ′) (3)

wherein ne denotes the rotation speed of an engine, η indicates a volumetric efficiency of the engine, v represents an engine displacement, p1 shows intake air pressure, p2 indicates engine back pressure, p3 denotes turbine back pressure of the turbocharger, ξ represents a loss coefficient of intake air flow rate control valve, ξ′ indicates a loss coefficient of recirculation gas control valve, f1 shows an intake air flow control valve flow rate characteristic, and f2 denotes a recirculation gas control valve flow rate characteristic.

In the meantime, the recirculation rate R of recirculation gas is expressed by R=G2/(G1+G2), as described above. In other words, it can be determined uniquely if the flow rate G1 of air passing through the intake flow rate control valve 5 and the flow rate G2 of air passing through the recirculation gas control valve are obtained. As given by the expression (2), the flow rate G1 of air passing through the intake flow rate control valve 5 can be controlled by loss coefficient ξ, namely, by the opening of the intake flow rate control valve 5. Similarly, as given by the expression (3), the flow rate G2 of air passing through the recirculation gas control valve 416 can be controlled by loss coefficient ξ′, namely, by the opening of the recirculation control valve 416. In other words, based on the values of flow rates G1 and G2, a feedback system is incorporated into the instruction system of the opening of the air intake control valve 45 and the opening of the recirculation gas control valve 416, whereby the recirculation rate R of recirculation gas can be placed under control.

Further, the control speed can be enhanced by correctly identifying the flow rate characteristics of the air intake control valve 45 and recirculation gas control valve 416. In other words, identify a change in the flow rate per unit time when the air intake control valve 45 is driven to change the intake flow rate, and a change in the flow rate per unit time when the recirculation gas control valve 416 is driven to change the intake flow rate. If a change in the flow rate per unit time when the air intake control valve 45 is driven to change the intake flow rate is greater than a change in the flow rate per unit time when the recirculation gas control valve 416 is driven to change the intake flow rate, namely, if the response of the air intake control valve 45 is faster that of the recirculation gas control valve 416, the air intake control valve 45 is controlled when there is a need for abruptly changing the exhaust gas recirculation rate. This enables the exhaust gas recirculation rate to be changed immediately to a predetermined target value, with the result that control speed is enhanced.

Referring to FIGS. 14 and 15, the following describes the configuration of the recirculation gas flow rate sensor 415 used in the exhaust gas recirculation device of an internal combustion engine in the present embodiment.

FIG. 14 is a partial cross sectional view showing the first configuration of the recirculation gas flow rate sensor used in the exhaust gas recirculation system of the internal combustion engine to which the present invention is applied. FIG. 15 is a partial cross sectional view showing the second configuration of the recirculation gas flow rate sensor used in the exhaust gas recirculation system of the internal combustion engine to which the present invention is applied.

The recirculation gas flow rate sensor 415 shown in FIG. 14 is used to measure the recirculation gas flow rate by the pressure inside the recirculation pipe. An area reduction section 153 is formed on the part of the inner wall surface of the recirculation pipe 13b. The low pressure side pressure sensor 152 is provided so that the sensing portion opens at the area reduction section 153. The high pressure side pressure sensor 151 is provided so that the sensing portion opens at the recirculation pipe 413b where the area reduction section 153 is not provided. The pressure inside the recirculation pipe 413b is measured by the low pressure side pressure sensor 152 and high pressure side pressure sensor 151. The low pressure side pressure sensor 152 is provided on the area reduction section 153, whereby the venturi effect based on the Bernoulli's law can be utilized. The exhaust gas recirculation controller 420 can obtains the recirculation gas flow rate G2 inside the recirculation pipe 413b from the differential pressure between two sensors 151 and 152. Further, a temperature sensor 4154 is provided to sense the temperature of the recirculation gas flowing inside the recirculation pipe 413b. The exhaust gas recirculation controller 420 corrects the recirculation gas flow rate G2 from the differential pressure between two sensors 151 and 152, by using the recirculation gas temperature sensed by the temperature sensor 154. The following arrangement can also be used. A circuit device is provided inside the recirculation gas flow rate sensor 415 to obtain the recirculation gas flow rate G2 from the differential pressure between two sensors 151 and 152 and to correct it according to the recirculation gas temperature sensed by the temperature sensor 154. The recirculation gas flow rate sensor 154 outputs the sensing signal of the recirculation gas flow rate G2 to the exhaust gas recirculation controller 420.

The recirculation gas flow rate sensor 415A of FIG. 15 uses a thermal resistor type sensor to sense the recirculation gas flow rate. The recirculation gas flow rate sensor 156 is installed on the wall surface of the recirculation pipe 413b. The recirculation gas flow rate sensor 156 is provided with a sensing element 157. It is used to measure the recirculation gas flow rate inside the recirculation pipe 413B. A current is supplied to the sensing element 157 so that the sensing element is maintained at a predetermined temperature. In response to the flow rate of the recirculation gas, there is a change in the amount of heat deprived from the sensing element 157. In this case, control is provided in such a way that the temperature of the sensing element 157 is kept constant. This procedure allows the current flowing through the sensing element 157 to provide a signal representing the recirculation gas flow rate. This method uses a thermal resistor type sensor which is capable of direct measurement of the mass flow rate, namely, the G2.

The aforementioned description refers to the configuration of the recirculation gas flow rate sensor 415. The sensor for sensing the pressure shown in FIG. 14 or the thermal resistor type sensor shown in FIG. 15 can be used as an intake air flow rate sensor 2.

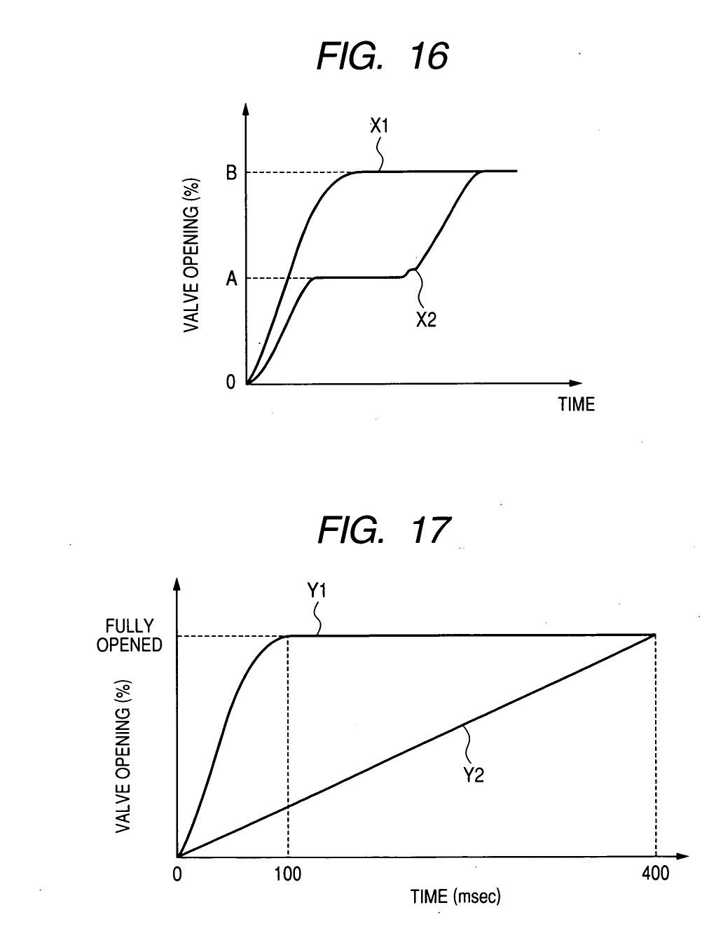

Referring to FIGS. 16 and 17, the following describes the characteristics of the air intake control valve 45 used in the exhaust gas recirculation device of an internal combustion engine according to the present embodiment.

FIGS. 16 and 17 are diagrams showing the characteristics resulting from the differences in the drive method of the air intake flow rate control valve used in the exhaust gas recirculation device as the present embodiment of the present invention. In FIGS. 16 and 17, the horizontal axis indicates time and the vertical axis represents the opening of the air intake flow rate control valve. The opening on the vertical axis is represented in terms of percentage, wherein the maximum opening is assumed as 100%.

In FIG. 16, the solid line X1 indicates the characteristics of the valve opening when an electronically controlled throttle actuator is used as an air intake control valve 45. The solid line X2 indicates the characteristics of the valve opening when a negative pressure throttle actuator is used as a air intake control valve 45.

The negative pressure throttle actuator indicated by the solid line X2 is cable of controlling only two openings—the valve opening A and full opening point B. The recirculation gas recirculation rate is difficult to place under the aforementioned feedback control.

In the meantime, use of an electronically controlled throttle actuator as indicated by the solid line X1 allows the stepless control in the range from the valve opening to the full opening point B. It permits easy feed back control. Such being the case, use of the electronically controlled throttle actuator indicated by the solid line X1 is more appropriate as the air intake control valve 45 for the present embodiment.

Referring to FIG. 17, the following describes the difference of characteristics resulting from the difference in the method of driving the electronically controlled throttle actuator. The solid line Y1 indicates the response of the throttle actuator wherein the target value is driven by a DC motor. The solid line Y1 indicates the response of the throttle actuator wherein the target value is driven by a stepping motor.

The stepping motor allows an open loop control to be used to ensure rotation in conformity to the drive pulse. The response speed is lower than that of the DC motor type, as is apparent from the characteristics indicated by the solid line Y2 in the drawing. Generally, high speed drive of a stepping motor is difficult due to the restrictions imposed in avoiding loss of synchronism. When the speed is increased, the stepping motor has to be increased in size, hence in cost.

By contrast, a compact-sized and high-speed DC motor is readily available. Further, when placed under position feedback control, the DC motor provides a preferred compact-sized, high-speed and low-cost drive source.

When viewed from control resolution, the drive step of the stepping motor represents control resolution, and this runs counter to the desired advantage of high speed. In the case of the DC motor, by contrast, it is determined by the resolution of the position sensor used in the feedback. A high resolution feedback system is readily established by using a continuous output type device such as a potentiometer.

Thus, a DC motor is preferred as the drive source of the electronically controlled throttle actuator. It should be noted that use of a brushless motor provides the same advantage as that obtained from using a DC motor.

As described above, in the present embodiment, even when there is a need for abrupt change of the exhaust gas recirculation rate, the abrupt change can be successfully handled by controlling the control valve characterized by higher response. In the meantime, when such an abrupt change is not needed, control accuracy is enhanced by using a control valve of lower response speed.

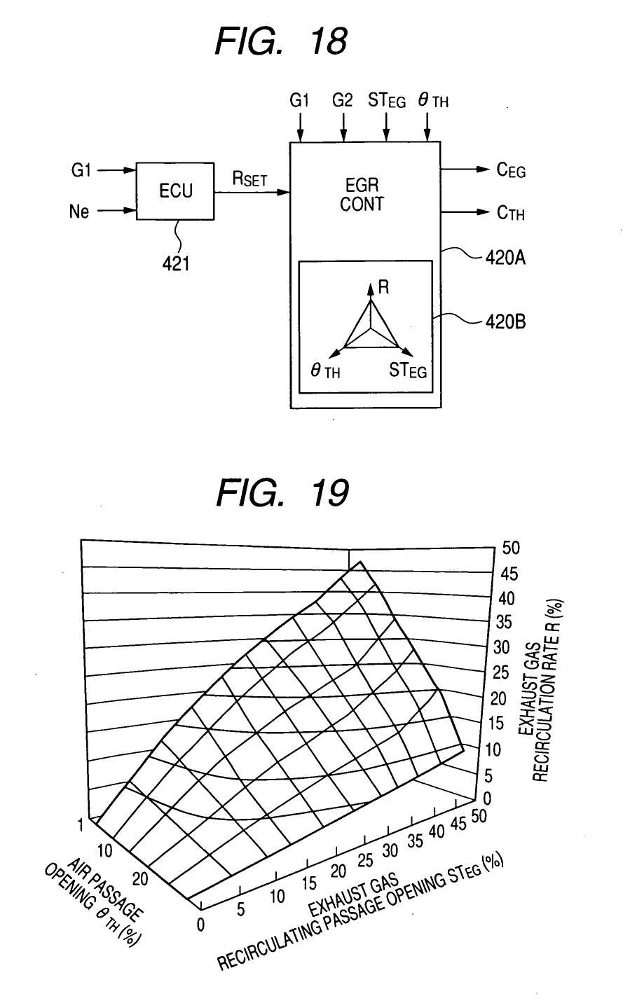

Referring to FIGS. 18 through 20, the following describes the configuration and operation of the exhaust gas recirculation control device of an internal combustion engine as another embodiment of the present invention. The configuration of the engine system using the exhaust gas recirculation control device of the internal combustion engine according to the present embodiment is the same as the one shown in FIG. 10.

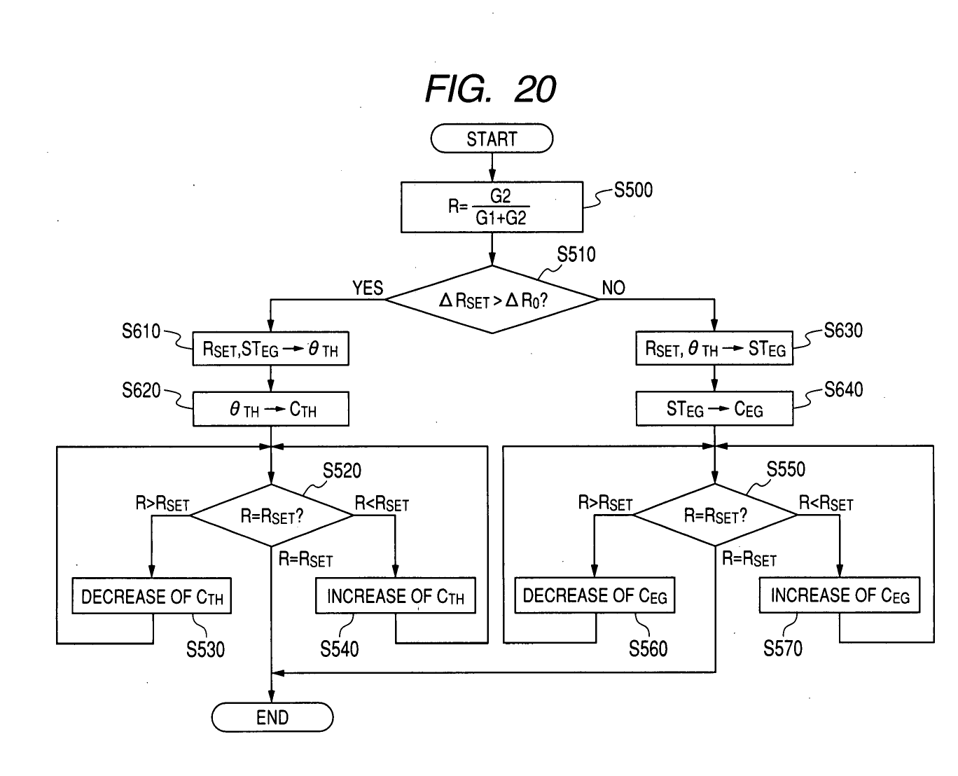

FIG. 18 is a block diagram showing the control system of the exhaust gas recirculation control device of an internal combustion engine as another embodiment of the present invention. It should be noted that the same reference numerals as those of FIG. 10 indicate the same components. FIG. 19 is a schematic diagram showing the map used in the exhaust gas recirculation control device of an internal combustion engine as another embodiment of the present invention. FIG. 20 is a flow chart showing the specific control items of the exhaust gas recirculation control device of an internal combustion engine as another embodiment of the present invention. It should be noted that the same reference numerals as those of FIG. 12 indicate the same components.

As shown in FIG. 18, in the present embodiment, the exhaust gas recirculation controller 420A install in a three-dimensional (3-D) map 420B. The recirculation gas recirculation rate instruction value RSET outputted by the ECU 421, the exhaust gas intake air rate signal G1 sensed by the intake air flow rate sensor 2, the recirculation gas flow rate G2 sensed by the recirculation gas flow rate sensor 415, the opening signal θTH from the intake flow rate control valve 5, and the stroke signal STEG from the recirculation gas control valve 416 are inputted into the exhaust gas recirculation controller 420A.

The exhaust gas recirculation controller 420A computes the exhaust gas recirculation rate R as (G2/(G1+G2)) based on the intake air rate signal G1 and the recirculation gas flow rate G2. To ensure that the recirculation rate R of exhaust gas will reach the target value R SET, the exhaust gas recirculation controller 420A uses the map 420B first to output the opening control signal CEG to the control valve 16, and to output the air intake flow rate control signal C TH to the intake flow rate control valve 5. The exhaust gas recirculation controller 420A also provides feedback control to output the opening control signal CEG to the recirculation gas control valve 416, and to output the air intake flow rate control signal CTH to the air intake control valve 45, whereby these valves 416 and 45 are placed under control.

Referring to FIG. 19, the following describes the details of the 3D map 420B. The 3D map 420B is a map representing the air passage opening θTH (%), recirculation passage opening S TEG (%) and recirculation rate R (%). When the air intake control valve 45 is comprised of a butterfly valve, the air passage opening θTH (%) represents the opening signal θTH in terms of percentage wherein the maximum opening is assumed as 100%. When the recirculation gas control valve 416 is a seat valve, the recirculation passage opening STEG (%) represents the stroke signal STEG in terms of percentage wherein the maximum stroke of the valve seat is 100%.

When the recirculation gas control valve 416 is a butterfly valve as in the previously described embodiment, the opening signal θTH is represented in terms of percentage, wherein the maximum opening is assumed as 100%, similarly to the case of the air intake control valve 45.

FIG. 19 shows the results of solving the aforementioned expressions (1), (2) and (3), wherein an engine is currently in the operation mode. For convenience in illustration, the indicated opening of the air intake control valve 45 ranges from 5 through 25% in the drawing. Similarly, the indicated opening of the recirculation rate control valve 414 ranges from 0 through 60%. The lattice point on the 3D map shows the relationship between the openings of the intake flow rate control valve 5 for meeting the recirculation gas recirculation rate and recirculation rate control valve. The 3D map 420B contains a plurality of 3D maps corresponding to the operation modes of the engine. When the lattice point on the map is selected using a map corresponding to a particular engine operation mode, the recirculation gas recirculation rate can placed under the open loop control.

When a change in the gas recirculation rate is observed with respect to changes in the openings of the intake flow rate control valve 5 and the recirculation gas control valve 416 shown in FIG. 19, the percentage of the change in the gas recirculation rate with respect to a change in the opening of the air intake control valve 45 is greater than the percentage of the change in the gas recirculation rate with respect to a change in the intake flow rate control valve 5. Further, although the valve opening of the electronically controlled throttle actuator ranges from 0 through 100%, the product operating a speed of 100 msec. or less is put into commercial use. In the range from 5 through 25% in FIG. 19, operation is possible at a speed of about 20 msec. Accordingly, in the example shown with reference to FIG. 19, the response of the air intake control valve 45 is faster than that of the recirculation gas control valve 416. Even if the recirculation gas recirculation rate instruction value RSET is subjected to an abrupt change in terms of pulse, no problem is raised by a change in the instruction value in terms of pulse if the intake flow rate control valve 5 as the electronically controlled throttle device is mainly operated. To be more specific, a change in the transparent engine operation status can be successfully met.

Referring to FIG. 20, the following describes the specific control items of the exhaust gas recirculation controller 420B. All the following control items are implemented by the exhaust gas recirculation controller 420B. The same step numbers as those of FIG. 12 indicates the same processing. In the present embodiment, the processing shown in Steps S610 through S640 is added to that given in FIG. 12.

In the Step S500 of FIG. 20, the exhaust gas recirculation controller 420B computes the exhaust gas recirculation rate R as (G2/(G1+G2)) based of the intake air rate signal G1 and recirculation gas flow rate G2.

In the Step S510, a decision is made to determine whether or not the change ΔR SET of the target value RSET of the recirculation rate R of exhaust gas inputted from the ECU 421 is greater than the reference value ΔR0 set in advance. If the change ΔR SET is greater than the reference value ΔR0, the process goes to the Step S610. If not, the process goes to the Step S630. In other words, in the Step S510, a decision step is taken to determine whether or not the target value R SET of the recirculation rate R of exhaust gas has made a substantial change. A decision step is taken to determine whether or not there is a need for an abrupt change in the exhaust gas recirculation rate in order to reduce the deleterious substance in the exhaust gas due to transient change in the operation conditions of the internal combustion engine.

If the change ΔR SET is greater than the reference value ΔR0, namely, if there is a need for an abrupt change in the exhaust gas recirculation rate, computation is made in the Step S610 to get the air passage opening θTH (%) as a target from the recirculation rate R corresponding to the recirculation gas recirculation rate instruction value R SET and the recirculation passage opening S TEG (%), using the 3D map 420B conforming to the current engine operation mode.

In the Step S620, the opening control signal C TH to be the air passage opening θTH (%) as a target is outputted to the intake flow rate control valve 5. Open loop control is provided to ensure that the opening of the air intake control valve 45 will become the air passage opening θTH (%) as a target. As described above, when the opening of the air intake control valve 45 is controlled to reach the air passage opening θTH (%) under open loop control, it is possible to come quickly close to the air passage opening θTH (%) as a target.

In the Step S520, a decision is made to see whether or not the recirculation rate R of exhaust gas calculated in the Step S510 is equal to the target value R SET of the recirculation rate R of exhaust gas.

If the recirculation rate R is greater than the target value R SET, control is provided in the Step S530 so that the opening control signal C TH outputted to the air intake control valve 45 is reduced, and the opening of the intake flow rate control valve 5 is also reduced. Then the process goes back to the Step S520. This procedure is repeated until the recirculation rate R is equal to the target value R SET.

In the meantime, when the recirculation rate R is smaller than the target value R SET, control is provided in the Step S540 so that the opening control signal C TH outputted to the air intake control valve 45 is increased, and the opening of the air intake control valve 45 is increased. Then the system goes back to the Step S520. This procedure is repeated until the recirculation rate R is equal to the target value R SET.

As described above, procedures of Steps S520, S530 and S540 are repeated, whereby feedback control is carried out until the recirculation rate R becomes equal to the target value R SET. Thus, the response of the air intake control valve 45 is faster than that of the recirculation gas control valve 416. This arrangement ensures an immediate change of the exhaust gas recirculation rate to a predetermined target value, even if there is a need for an abrupt change in the exhaust gas recirculation rate.

In the meantime, if it has been determined in the Step S510 that the change ΔR SET is smaller than the reference value ΔR0, namely, there is not much change in the exhaust gas recirculation rate, then computation is made in the Step S630 to get the recirculation passage opening S TEG (%) as a target from the recirculation rate R corresponding to the recirculation gas recirculation rate instruction value R SET and the air passage opening θTH (%), using the 3D map 420B conforming to the current engine operation mode.

In the Step S240, the opening control signal CEG to be the recirculation passage opening S TEG (%) as a target is outputted to the recirculation gas control valve 416. Open loop control is provided to ensure that the opening of the recirculation gas control valve 416 will become the recirculation passage opening S TEG (%) as a target.

In the Step S550, a decision is made to see whether or not the recirculation rate R of exhaust gas calculated in the Step S510 is equal to the target value R SET of the recirculation rate R of exhaust gas.

If the recirculation rate R is greater than the target value R SET, control is provided in the Step S560 so that the opening control signal C EG outputted to the recirculation gas control valve 416 is reduced, and the opening of the recirculation gas control valve 416 is also reduced. Then the system goes back to the Step S550. This procedure is repeated until the recirculation rate R becomes equal to the target value R SET.

In the meantime, when the recirculation rate R is smaller than the target value R SET, control is provided in the Step S570 so that the opening control signal C EG outputted to the recirculation gas control valve 416 is increased, and the opening of the recirculation gas control valve 416 is increased. Then the system goes back to the Step S550. This procedure is repeated until the recirculation rate R is equal to the target value R SET.

As described above, procedures of Steps S550, S560 and S570 are repeated, whereby feedback control is carried out until the recirculation rate R becomes equal to the target value R SET. In this case, the response of the recirculation gas control valve 416 is slower than that of the air intake control valve 45. This means that finer opening control is enabled. This ensures a precise change of the exhaust gas recirculation rate to a predetermined target value.

In the above description, the response of the air intake control valve 45 is faster than that of the exhaust gas recirculation control valve 416. Conversely, the response of the exhaust gas recirculation control valve 416 is faster than that of the air intake control valve 45 in some cases. In such cases, if there is a need for an abrupt change of the exhaust gas recirculation rate, the recirculation gas control valve 416 characterized by faster response is first placed under open loop control and is then placed under feedback control. If there is no need of an abrupt change, the intake flow rate control valve 5 of slower response is placed under control. This arrangement ensures enhanced control precision.

As described above, in the present embodiment, even if there is a need for an abrupt change of the exhaust gas recirculation rate, the control valve of faster response is first placed under open loop control so as to provide quick movement of the valve close to the target opening. Then it is placed under feedback control so as to converge on the target opening. This arrangement successfully meets the abrupt change. In the meantime, when such an abrupt change is not needed, control accuracy is enhanced by using a control valve of lower response speed.

The following summarizes the features of the EGR control system of the present embodiment described above.

In the internal combustion engine such as a diesel engine, the aforementioned exhaust gas recirculation control is crucial to the purification of exhaust gas or reduction of the emission of nitrogen oxides (NOx) in particular. In an exhaust gas recirculation control device according to the conventional art, the opening of the exhaust gas recirculation valve has been controlled so as to reach a predetermined exhaust gas recirculation rate, as disclosed in the Japanese Application Patent Laid-open Publication No. 2003-83034, Official Gazette of Japanese Patent No. 3329711, and Official Gazette of Japanese Patent Tokuhyo 2003-516496.

However, according to the conventional art of controlling the opening of the exhaust gas recirculation valve, it has been difficult to provide proper control when there is a need for an abrupt change in the exhaust gas recirculation rate in order to reduced the deleterious substance in the exhaust gas to cope with a transient change in operation conditions, in particular over the entire operation range of the internal combustion engine.

The object of the present invention is to provide an exhaust gas recirculation control device characterized by enhanced response speed and accuracy in the control of exhaust gas recirculation flow rate of an internal combustion engine.

(1) To achieve the aforementioned object, the present embodiment is arranged as follows.

An exhaust gas recirculation control valve of an internal combustion engine comprising:

a recirculation rate control valve for controlling the exhaust gas recirculation flow rate in the exhaust gas recirculation passage of the internal combustion engine;

an air intake control valve for controlling the air flow rate in the air intake passage in the internal combustion engine; and

control means for feedback control of the air intake control valve and/or recirculation gas control valve to ensure that the exhaust gas recirculation rate obtained from the outputs based on the intake air flow rate sensor and recirculation gas flow rate will reach the target recirculation rate.

This arrangement enhances response speed and accuracy in the control of exhaust gas recirculation flow rate of an internal combustion engine.

(2) The exhaust gas recirculation control valve mentioned in the aforementioned Structure (1), wherein the aforementioned control means is preferably arranged in such a way that, when there is an abrupt change in the target value of the recirculation rate, the air intake control valve or recirculation gas control valve, whichever has the faster response, is placed under feedback control.

(3) The exhaust gas recirculation control valve in the aforementioned Structure (1), preferably provided with the opening of the aforementioned recirculation gas control valve; the opening of the aforementioned air intake control valve; and a plurality of 3D maps defined by a combination with the recirculation rate; wherein the aforementioned control means selects a 3D map conforming to the operation mode of the internal combustion engine and controls the air intake control valve and/or recirculation gas control valve in such a way that the exhaust gas recirculation rate obtained from the outputs from the intake air flow rate sensor and recirculation flow rate sensor will reach the target recirculation rate.

(4) The exhaust gas recirculation control valve mentioned in the aforementioned Structure (2), wherein the aforementioned control means is preferably arranged in such a way that, when there is an abrupt change in the target value of the recirculation rate, the air intake control valve or recirculation gas control valve, whichever has the faster response, is placed under control.

(5) The exhaust gas recirculation control valve mentioned in the aforementioned Structure (1), wherein the aforementioned exhaust gas recirculation flow rate sensor preferably detects the recirculation flow rate based on the differential pressures at least two positions in the exhaust gas recirculation passage, or detects the mass flow rate in the exhaust gas recirculation passage, and the aforementioned intake air flow rate sensor detects the recirculation flow rate based on the differential pressures at least two positions in the air intake passage, or detects the mass flow rate in the air intake passage.

(6) The exhaust gas recirculation control valve mentioned in the aforementioned Structure (1), wherein the air intake control valve is a throttle actuator based on electronic control method.

### INDUSTRIAL FIELD OF APPLICATION

The present invention provides a diesel engine EGR control device and motor driven throttle valve apparatus characterized by enhanced control of the EGR and others.

What is claimed:

1. An EGR control device for diesel engine, wherein part of exhaust gas is recirculated into an air intake passage of said diesel engine, said EGR control device comprising:
a throttle valve for controlling an opening of said air intake passage under EGR control;
an EGR valve for controlling a flow rate of exhaust gas recirculated into said air intake passage;
a first air intake body equipped with said throttle valve, a drive motor thereof and a reduction gear mechanism; and
a second air intake body into which an exhaust gas recirculation passage part with said EGR valve is incorporated, and which is equipped with a drive motor of said EGR valve and a reduction gear mechanism;
wherein said first and second air intake bodies are connected to each other as a single-assembly, and are provided with a first and second covers for covering corresponding said reduction gear mechanisms, respectively; and a circuit board for driving and controlling at least said throttle valve is incorporated in at least one of said first and second covers.

2. The EGR control device according to claim 1, wherein said throttle valve is used for at least one of prevention of dieseling and regeneration of a diesel particulate filter other than EGR control.

3. The EGR control device according to claim 1, wherein said circuit board for controlling said throttle valve and EGR valve is composed of a single board.

4. The EGR control device according to claim 1, wherein said device is configured to send EGR valve control signal produced by said circuit board to the drive motor of said EGR motor through from a connector terminal provided on said first cover to a connector terminal provided on said second cover.

5. The EGR control device according to claim 1, wherein said circuit board is configured to take in a signal of a target EGR rate sent from a high-order engine control unit arranged outside said covers, and to compute a throttle valve opening and an EGR valve opening required under EGR control based on said target EGR rate.

6. An EGR control device for diesel engine, wherein part of exhaust gas is recirculated into an air intake passage of said diesel engine, said EGR control device comprising:
a throttle valve for controlling an opening of said air intake passage under EGR control;
an EGR valve for controlling a flow rate of exhaust gas recirculated into said air intake passage;
a throttle body equipped with said throttle valve, a drive motor thereof and a reduction gear mechanism;
a resin cover attached on said throttle body for covering said reduction gear;
a circuit board incorporated into said resin cover for driving and controlling said throttle valve;
a step down circuit installed on said circuit board for stepping down a battery voltage into a motor power supply voltage.

7. An EGR control device for diesel engine, wherein part of exhaust gas is recirculated into an air intake passage of said diesel engine, said EGR control device comprising:
a throttle valve for controlling an opening of said air intake passage under EGR control;
an EGR valve for controlling a flow rate of exhaust gas recirculated into said air intake passage;
a throttle body equipped with said throttle valve, a drive motor thereof and a reduction gear mechanism;
a resin cover attached on said throttle body for covering said reduction gear; and
a circuit board incorporated into said resin cover for driving and controlling said throttle valve;
wherein said circuit board is mounted on a heat sink having a higher thermal conductivity than that of said resin cover; said heat sink is installed in said resin cover in such a manner of being led through said resin cover; and a heat radiation surface of said heat sink is exposed to the outside.

8. The EGR control device according to claim 7, wherein said circuit board is equipped with a circuit for driving and controlling said EGR valve, in addition to said throttle valve.

9. The EGR control device according to claim 7, wherein said heat sink is provided with a cooling water pipe.

10. An EGR control device for diesel engine, wherein part of exhaust gas is recirculated into an air intake passage of said diesel engine, said EGR control device comprising:
a throttle valve for controlling an opening of said air intake passage under EGR control;
an EGR valve for controlling a flow rate of exhaust gas recirculated into said air intake passage;
a throttle body equipped with said throttle valve, a drive motor thereof and a reduction gear mechanism;
a resin cover attached on said throttle body for covering said reduction gear;
a circuit board incorporated into said resin cover for driving and controlling said throttle valve; and
a diesel particulate filter installed on an exhaust gas passage of said diesel engine;
wherein said circuit board is provided with a circuit for controlling the opening of said throttle valve to burn particulate substance deposited on said diesel particulate filter.

11. The EGR control device for diesel engine described in claim 10, wherein said circuit board is equipped with a circuit for driving and controlling the EGR valve, in addition to said throttle valve.

12. A motor driven throttle valve device comprising:
a throttle valve for controlling an opening of an air intake passage of an internal combustion engine under EGR control;
an EGR valve for controlling a flow rate of exhaust gas recirculated into said air intake passage;
a first air intake body equipped with said throttle valve, a drive motor thereof and a reduction gear mechanism; and
a second air intake body into which an exhaust gas recirculation passage part with said EGR valve is incorporated, and which is equipped with a drive motor of said EGR valve and a reduction gear mechanism;
wherein said second air intake body is connected to said first air intake body in series at downstream from said first air intake body; said first and second air intake bodies are provided with a first and second covers for covering reduction gear mechanisms respectively; a throttle valve shaft and an EGR valve shaft are arranged in parallel in the vertical direction; and said reduction gears for these shafts and said first and second covers are arranged in parallel on the side surface of said first and second air intake bodies.

13. The motor driven throttle valve device according to claim 12, wherein said first and second covers are separately or integrally molded.

14. The motor driven throttle valve device according to claim 12, wherein said first cover is provided with a sensor for sensing the opening of said throttle valve, whereas said second cover is provided with a sensor for sensing the opening of said EGR; and said first and second covers are provided with connectors containing at least an output terminal for sending a signal from each sensor to an engine control unit, a terminal for supplying power to said drive motor, a ground terminal and an input terminal for taking in control signals for each valves.

15. The motor driven throttle valve device according to claim 14, wherein said connector is oriented upstream from said throttle valve.

16. A motor driven throttle valve device comprising:
a throttle body forming an air intake passage;
a throttle valve installed into said air intake passage to reduce an cross section of said air intake passage according to an engine operation mode;
a throttle valve shaft supported by said throttle body, said throttle valve being fixed on said throttle valve shaft;
a motor mounted on said throttle body;
a reduction gear mechanism for transmitting a rotation of said motor to said throttle valve shaft;
a resin cover attached on said throttle body so as to cover the gear mechanism;
a control circuit installed into said resin cover;
a connector provided integrally with terminals provided on said resin cover by insert-molding to output an EGR valve control signal sent from said control circuit.

17. The motor driven throttle valve device according to claim 16, wherein said connector includes a terminal for receiving the signal indicating the status of said engine used to compute the EGR valve control signal.

18. The motor driven throttle valve device according to claim 16, wherein the output signal of a throttle position sensor for sensing the rotational angle of said throttle valve shaft is inputted into said control circuit.

19. The motor driven throttle valve device according to claim 16, wherein said connector contains a terminal for outputting to the outside the output signal of said throttle position sensor which senses the rotational angle of said throttle valve shaft.
